(19) United States
(12) Patent Application Publication
(10) Pub. No.: US 2026/0307493 A1
(43) Pub. Date: Oct. 8, 2026

(54) SYSTEMS AND METHODS FOR PREDICTING LOOSE CONNECTION IN BATTERY ENERGY STORAGE SYSTEM FOR ELECTRIC VEHICLE

(71) Applicant: LG Energy Solution, Ltd., Seoul (KR)

(72) Inventors: Dinesh Kumar Murugesan, Westborough, MA (US); Kiran Kumar, Westborough, MA (US)

(73) Assignee: LG Energy Solution, Ltd., Seoul (KR)

(21) Appl. No.: 19/640,162

(22) Filed: Apr. 6, 2026

Related U.S. Application Data
(60) Provisional application No. 63/784,820, filed on Apr. 7, 2025.

(51) Int. Cl. B60L 3/00; B60L 58/16; G06N 20/00; G07C 5/08; G07C 5/10; H01M 10/42; H01M 10/48

(52) U.S. Cl. CPC B60L 3/0046; B60L 58/16; G06N 20/00; G07C 5/0816; G07C 5/10; H01M 10/425; H01M 10/482; H01M 10/486; B60L 2240/545; B60L 2240/549; H01M 2010/4271; H01M 2220/20

(57) ABSTRACT

A method includes receiving, by one or more processors, a data set associated with a battery system, wherein the data set includes sensed current values associated with batteries over a period of time. The method includes determining threshold values based on an operating state or sensed current values of the battery system. The method includes applying a machine learning model to the data set to determine that the data set meets threshold values associated with a loose connection, wherein the model is trained offline at intervals so that system resources remain below a threshold and a controller performs the determination within a predetermined time. The method includes controlling an operation of the battery system based on the determination that the data set meets threshold values associated with the loose connection.

### CROSS-REFERENCE TO RELATED APPLICATIONS

This application claims benefit to U.S. Provisional Patent Application No. 63/784,820, filed Apr. 7, 2025, the contents of which are incorporated by reference in its entirety.

### TECHNICAL FIELD

Various embodiments of the present disclosure relate generally to systems and methods for battery energy storage system monitoring and control, and more particularly to machine-learning based predictive health assessment and loose connection detection for battery energy storage systems.

### BACKGROUND

Batteries have emerged as critical components in modern energy infrastructure. The importance of battery technology continues to grow as the global energy transition accelerates and intermittent renewable sources capture larger shares of the electricity supply mix.

Commercially available batteries may include nickel-cadmium batteries, nickel-hydrogen batteries, nickel-zinc batteries, lithium, sodium-ion, lithium iron phosphate, lithium-sulfur, solid-state batteries, and the like. Among these, lithium batteries may be gaining attention due to their advantageous characteristics: they can be charged and discharged freely without memory effects, they exhibit very low self-discharge rates, and they provide high energy density compared to nickel-based alternatives. Similarly, sodium-ion batteries are emerging as promising alternatives to lithium batteries, driven by the abundance of sodium resources and their potential cost advantages..

In general, battery packs or racks typically comprise multiple cells or cell stacks arranged in series or parallel configurations. Each cell or cell stacks contains either a single battery cell or multiple battery cells connected in series. The operational state of each cell stack within the battery pack is continuously monitored by a controller equipped with a battery management system. Battery cells may be integrated directly into packs or racks, or alternatively organized into modules, with these modules then connected in series or parallel arrangements to form complete battery packs or racks. The state of each cell stack included in the battery pack may be monitored by a controller having a battery management system mounted thereon. The controller may output signals for controlling the balancing operation, cooling operation, and discharging operation based on the monitored state from each cell stack.

Batteries are increasingly being integrated into a wide range of mobile devices, including smartphones, laptops, electric vehicles (EVs), hybrid electric vehicles (HEVs), plug-in hybrid electric vehicles (PHEVs), and energy storage systems (ESS). Many batteries used in a vehicle require additional safety precautions. The batteries may be included in a battery system with a battery enclosure. The battery enclosure may contain various components, such as battery cells, a battery cooling plate assembly, a box cover, one or more sensors, and a controller.

As battery systems become more complex and operate under increasingly demanding conditions, maintaining reliable electrical connections between battery components becomes a significant challenge. Battery systems may typically include multiple battery cells or modules connected through various electrical connections, including bus bars, cables, and terminal connections. These connections may be subject to mechanical stress from factors such as temperature cycling, vibration, and normal wear over time. Temperature variations during battery operation may cause expansion and contraction of connection components, potentially leading to gradual loosening of mechanical fasteners. Vibrations from vehicle operation, road conditions, and other environmental factors can further contribute to connection degradation. Additionally, oxidation and corrosion at connection interfaces can increase electrical resistance and compromise connection integrity over time.

Traditional battery management systems may focus on monitoring cell-level parameters such as voltage, current, and temperature to assess battery health and performance. However, these systems may have limitations in detecting intermittent or progressive connection issues that develop gradually over time. Connection problems may manifest as subtle changes in current distribution patterns or resistance variations that occur before more obvious symptoms become apparent.

Early detection of connection issues in battery systems may provide opportunities for proactive maintenance and help prevent more serious failures. However, identifying loose or degraded connections may present technical challenges, particularly when such issues are intermittent or develop slowly over extended periods.

The present disclosure is directed to overcoming one or more of these above-referenced challenges.

### SUMMARY OF THE DISCLOSURE

In some aspects, the techniques described herein relate to a method comprising: receiving, by one or more processors, a data set associated with a battery system, wherein the data set includes one or more sensed current values associated with one or more batteries of the battery system over a period of time; determining one or more threshold values based on one or more of an operating state of the battery system or the one or more sensed current values associated with the one or more batteries of the battery system; applying, by the one or more processors, a machine learning model to the data set to generate a determination that the data set meets the one or more threshold values associated with the battery system having a loose connection, wherein the machine learning model is trained at one or more intervals, and wherein the machine learning model is trained offline, such that when the machine learning model is implemented within the battery system, one or more resources of the battery system remains below a resource threshold, so that a controller of the battery system performs the determination within a predetermined amount of time; and controlling, by the one or more processors, an operation of the battery system based on the determination that the data set meets the one or more threshold values associated with the battery system having the loose connection.

In some aspects, the techniques described herein relate to a method further comprising: removing, by the one or more processors, invalid data from the data set based on one or more data state variables; filtering, by the one or more processors, the data set using a moving average filter; and generating the one or more sensed current values associated with the one or more batteries of the battery system over the period of time using one or more sensors.

In some aspects, the techniques described herein relate to a method wherein the one or more data state variables includes one or more sensed current values associated with one or more batteries of the battery system not exceeding 10% of a maximum load of the battery system.

In some aspects, the techniques described herein relate to a method wherein the machine learning model is trained by: receiving first data regarding an element attribute, wherein the first data is associated with the battery system; extracting a first feature from the first data; receiving second data regarding a training prediction value related to the element attribute; extracting a second feature from the second data; and training the machine learning model to learn an association between the element attribute and the training prediction value related to the element attribute, based on the first feature and the second feature.

In some aspects, the techniques described herein relate to a method wherein extracting the first feature includes: averaging, by the one or more processors, one or more sensed current values associated with one or more batteries of the battery system; determining, by the one or more processors, a deviation for each of the one or more sensed current values based on averaging the one or more sensed current values; and determining, by the one or more processors, the first feature based on the deviation for each of the one or more sensed current values that meets a deviation threshold.

In some aspects, the techniques described herein relate to a method wherein determining the first feature further includes: applying, by the one or more processors, one or more dot products including one or more weights to the first feature; adding, by the one or more processors, one or more biases to the first feature; and applying, by the one or more processors, a sigmoid activation function to the first feature.

In some aspects, the techniques described herein relate to a method wherein the machine learning model includes one or more hidden layers, wherein the one or more hidden layers are associated with the first feature and the second feature.

In some aspects, the techniques described herein relate to a method wherein determining the one or more threshold values further includes: determining the one or more threshold values based on a deviation value associated with each of the one or more sensed current values, wherein the deviation value is based on one or more of historical data or one or more system characteristics of the one or more batteries of the battery system.

In some aspects, the techniques described herein relate to a method further comprising: generating, by the one or more processors, a notification based on the determination that the data set meets the one or more threshold values; and outputting, by the one or more processors, the notification, wherein the notification includes one or more indications or one or more predictions of the loose connection of the battery system.

In some aspects, the techniques described herein relate to a method wherein: the one or more indications include one or more of a connection strength percentage, an oxidation percentage, or a resistance increase percentage, and the one or more predictions include one or more of a prediction of the connection strength percentage over time, a prediction of the oxidation percentage over time, or a prediction of the resistance increase percentage over time.

In some aspects, the techniques described herein relate to a method wherein the operation includes one or more of changing an operating state of the one or more batteries of the battery system, limiting an operational load of each of the one or more batteries, reducing the operational load of the one or more batteries, or preventing a next start operation of the battery system.

In some aspects, the techniques described herein relate to a method wherein the data set further includes one or more sensed temperature values associated with the one or more batteries of the battery system.

In some aspects, the techniques described herein relate to a method further comprising: adjusting the one or more threshold values based on one or more of: an age of a vehicle containing the battery system, a type of the vehicle, a number of batteries of the battery system, or an operating history of the battery system.

In some aspects, the techniques described herein relate to a method wherein the machine learning model is trained using historical data from a plurality of battery systems under various connection conditions, including normal connection conditions and progressively loosened connection conditions with different degrees of resistance increase.

In some aspects, the techniques described herein relate to a method for battery health monitoring in a battery energy storage system, the method comprising: receiving, by one or more processors, operational data from a plurality of batteries of the battery energy storage system; applying, by the one or more processors, a machine learning model to the operational data from the plurality of batteries to generate a determination that the operational data meets one or more threshold values associated with a battery health assessment, wherein applying the machine learning model to the operational data includes: detecting, by the one or more processors, one or more abnormal current patterns in the operational data, detecting, by the one or more processors, one or more connection failure progressions based on the one or more abnormal current patterns and historical degradation data in the operational data, and generating, by the one or more processors, the battery health assessment based on the one or more abnormal current patterns and the one or more connection failure progressions; and initiating, by the one or more processors, a maintenance action when the battery health assessment meets the one or more threshold values.

In some aspects, the techniques described herein relate to a method wherein detecting the one or more abnormal current patterns includes: determining one or more statistical deviation currents for each of one or more connected batteries from an average current value; detecting current imbalances for each of the one or more connected batteries based on the one or more statistical deviation currents for each of the one or more connected batteries; determining one or more correlations corresponding to one or more current pattern changes with vehicle operational conditions including a temperature variation and a vibration level based on the current imbalances for each of the one or more connected batteries; and determining the one or more abnormal current patterns by distinguishing between a temporary current variation and a persistent current pattern indicative of connection degradation for each of the one or more connected batteries based on the one or more correlations.

In some aspects, the techniques described herein relate to a method wherein detecting the one or more connection failure progressions includes analyzing changes in one or more current values from each of the plurality of batteries at one or more intervals during operation.

In some aspects, the techniques described herein relate to a method for training a machine learning model to predict a health of a battery in a battery energy storage system, the method comprising: receiving, by one or more processors, first data associated with each of a plurality of batteries of the battery energy storage system, wherein the first data includes a plurality of operational parameters; extracting, by the one or more processors, one or more features from the first data based on analyzing processing algorithms identifying one or more battery operational parameters; training, by the one or more processors, the machine learning model to determine correlations between the plurality of operational parameters and one or more health assessment values based on the one or more features; and validating, by the one or more processors, the machine learning model using validation data.

In some aspects, the techniques described herein relate to a method wherein the plurality of operational parameters includes one or more of a sensed current value, a charging rate, a sensed temperature value, or a load limitation.

In some aspects, the techniques described herein relate to a method wherein the one or more health assessment values include one or more of a current deviation or a current average.

Additional objects and advantages of the disclosed embodiments will be set forth in part in the description that follows, and in part will be apparent from the description, or may be learned by practice of the disclosed embodiments. The objects and advantages of the disclosed embodiments will be realized and attained by means of the elements and combinations particularly pointed out in the appended claims.

It is to be understood that both the foregoing general description and the following detailed description are exemplary and explanatory only and are not restrictive of the disclosed embodiments, as claimed.

### BRIEF DESCRIPTION OF DRAWINGS

The accompanying drawings, which are incorporated in and constitute a part of this specification, illustrate various exemplary embodiments and together with the description, serve to explain the principles of the disclosed embodiments.

FIG. 1 depicts an exemplary system infrastructure for a vehicle, according to one or more embodiments.

FIG. 2 depicts a battery, according to one or more embodiments.

FIG. 3 depicts a controller, according to one or more embodiments.

FIG. 4 depicts a flow diagram for training a machine learning model, according to one or more embodiments.

FIG. 5 depicts a flow diagram for detecting loose connections in a battery system, according to one or more embodiments.

FIG. 6 depicts a flowchart illustrating data preprocessing for detecting loose connections in a battery system of FIG. 5, according to one or more embodiments.

FIG. 7 depicts a flowchart showing feature extraction for detecting loose connections in a battery system of FIG. 5, according to one or more embodiments.

FIG. 8 depicts a flowchart illustrating machine learning model selection and deployment for detecting loose connections in a battery system of FIG. 5, according to one or more embodiments.

FIG. 9 depicts a flowchart for detecting and responding to loose connections in a battery system, according to one or more embodiments.

### DETAILED DESCRIPTION

Both the foregoing general description and the following detailed description are exemplary and explanatory only and are not restrictive of the features, as claimed. As used herein, the terms “comprises,” “comprising,” “has,” “having,” “includes,” “including,” or other variations thereof, are intended to cover a non-exclusive inclusion such that a process, method, article, or apparatus that comprises a list of elements does not include only those elements, but may include other elements not expressly listed or inherent to such a process, method, article, or apparatus. In this disclosure, unless stated otherwise, relative terms, such as, for example, “about,” “substantially,” and “approximately” are used to indicate a possible variation of ±10% in the stated value. In this disclosure, unless stated otherwise, any numeric value may include a possible variation of ±10% in the stated value.

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section.

Various embodiments of the present disclosure relate generally to systems and methods for battery energy storage system monitoring control, and more particularly to machine-learning based predictive health assessment and loose connection detection for battery energy storage systems.

Batteries may have a variety of shapes, also known as form factors. Common battery form factors include pouch-type, prismatic-type, and cylindrical-type.

Pouch-type battery cells can be produced in various lengths and widths, which may enhance the battery capacity and allow optimization of battery cells. The flexible pouch-type battery can provide significant advantages over rigid battery formats, including improved mechanical flexibility that allows the battery to conform to curved or irregular surfaces in electronic devices. This flexibility enables manufacturers to integrate pouch-type batteries into compact spaces and unconventional form factors, such as wearable devices, smartphones with curved displays, and automotive applications where space constraints require batteries to fit around other components. The lightweight and thin profile of pouch-type batteries also facilitates easier incorporation into products where weight and thickness are critical design considerations, such as tablets, laptops, and electric vehicle applications. Additionally, the pouch format allows for more efficient use of available space within a device enclosure, as the flexible packaging can be shaped to increase energy density while reducing wasted volume compared to cylindrical or prismatic battery formats.

Prismatic battery cells offer may offer advantages in applications requiring efficient space utilization and thermal management. Their rectangular form factor allows for optimal packing density within battery modules and packs, reducing wasted space and enabling higher energy density per unit volume. The flat surfaces of prismatic cells may facilitate improved heat dissipation and thermal contact with cooling systems, which can enhance overall battery performance and safety. The outer shell of prismatic cells are typically made of aluminum alloy or steel, and are typically heavier than pouch-type battery cells, making them ideal for situations where weight is a less important design consideration.

Cylindrical battery cells may provide robust mechanical strength and proven manufacturing scalability that may benefit high-volume production applications. The cylindrical geometry distributes internal pressure more evenly during charging and discharging cycles, potentially contributing to enhanced structural integrity and longer cycle life. These cells may also offer advantages in automated manufacturing processes due to their uniform shape and established production techniques, which can result in consistent quality and cost-effective mass production. Cylindrical cells are typically heavier than prismatic cells, and further have reduced energy density, as packing the batteries together typically results in gaps or spaces between the cells that are not present in pouch and prismatic form factor designs.

Modules and packs can be produced in various designs to accommodate various products. Batteries may include one or more of a tab structure, a tab-less structure, or a jelly roll design. A tab-less jelly roll design may reduce resistance while increasing power output. A zig-zag stacking design may include cross-stacking technology that alternates cathode and anode sheets with separators, enhancing both precision and safety. A Cell Array Structure (CAS) structure for batteries may increase structural rigidity, enhance cooling efficiency, and ensure superior safety.

The assembly of the "cylindrical battery", the most commonly encountered battery form in our daily life, starts with "winding". Winding is a process where a machine called a winder rolls up the cathode and anode electrodes. This process has the advantage of being very fast, similar to how a "tissue roll" can quickly wrap the paper around the tissue core. During winding, cathode, anode, and separator rolls are unwound, and an aluminum tab is attached to the cathode's blank part while a copper tab is attached to the anode's blank part. Then they are attached to the winder in the order of cathodeseparator-anode-separator, wound around a mandrel, like rolling toilet paper around its core, and then cut into an appropriate size to form a jelly roll.

Once the jelly roll is formed, it goes through various assembly processes to take the form of the familiar cylindrical battery. At first, the jelly roll produced by the winding method is inserted into a can so that the anode touches its bottom and the anode tab is bent at a 90-degree angle to make contact with the anode. After inserting the jelly roll into the can, it is attached using a resistance welding method. Resistance welding is also known as "spot welding" because bead-like spots are created when the metal melts and solidifies. After welding, a process called "beading" is used to create the neck of the cell, allowing the top cap to be fitted later.

Once the cylindrical shape of the battery is completed through beading, electrolyte is injected. To do this, a vacuum is created inside of the can and the electrolyte is injected into it through a nozzle. Then, the can is pressed to let the electrolyte fill the pores of the electrode. Once the electrolyte injection is complete, the cathode tab and the top cap are attached to the cell using laser welding. Finally, the cylindrical battery is completed by mechanically sealing it through the crimping and sizing processes, producing it to standardized dimensions. After the assembly process is completed, the battery undergoes cleaning, quality verification, and formation processes before being delivered to the customers.

Pouch-type batteries may be manufactured differently from cylindrical batteries. To place battery materials into the electrode pocket of a pouch case, a mono-cell is required. A mono-cell is the basic unit of a battery, consisting of a cathode, an anode, and two separators arranged in a layered structure, such as "separator - central electrode - separator - external electrode." The lamination and stacking processes are applied to this mono-cell. To be more specific, the process begins with lamination, a method for aligning and bonding the cathode, anode, and separator. This is followed by stacking, during which monocells are repeatedly layered. Finally, stacking half-cells - each made up of two separators and an anode - forms a cell stack, where the cathode and anode are alternately layered with separators in between. Lamination & stacking technology increases space efficiency within the pouch case, further enhancing energy density. Stacking, which involves individually layering battery cells, requires advanced technical expertise. By applying lamination & stacking, misalignment between cells is reduced, and empty spaces within the battery cell are eliminated, resulting in higher energy density. Lamination & stacking technology with mono-cells may be used to produce a range of pouch-type batteries, from ultra-thin batteries under 2mm to long cells.

The cell stack, produced through lamination and stacking, then moves to the packaging stage. First, leads are welded onto the cell stack, which comprises multiple layers of mono-cells. Next, a pouch film is compressed to form a pocket, and the lead-welded cell stack is inserted into this pouch pocket for assembly. To seal the pocket, heat and pressure are applied using a sealing tool.

During this process, two pockets are formed: the electrode pocket and the gas pocket. The electrode pocket houses the cell stack, including the cathode, anode, separator, and electrolyte. The gas pocket, meanwhile, serves as an entry for electrolyte injection and as a space to store gases generated during the injection process. After injecting the electrolyte into the gas pocket, the injection port is sealed with the sealing tool, completing the assembly of the pouchtype battery. In the following formation process, any unwanted gases that are generated and accumulated in the gas pocket are removed during the degassing stage by trimming the gas pocket.

Prismatic battery cell manufacturing may share some similarities with cylindrical cell production, while incorporating unique processes tailored to the rectangular form factor. The manufacturing process typically begins with electrode preparation, where cathode and anode materials are coated onto current collectors, similar to other battery types. However, prismatic cells may utilize either a winding process similar to cylindrical cells or a stacking process similar to pouch cells, depending on the specific design requirements and manufacturer preferences. The electrode assembly is then inserted into a rigid metal casing, which may be made of aluminum alloy or steel, providing structural integrity that differs from the flexible pouch format.

The assembly and sealing processes for prismatic cells may involve specialized techniques that accommodate the rectangular geometry and rigid housing. Electrolyte injection in prismatic cells may require precise control to ensure uniform distribution throughout the rectangular cell structure, which can be more challenging than the cylindrical geometry due to potential dead zones in corners. The sealing process typically involves laser welding or mechanical crimping of the metal casing, providing a hermetic seal that may offer enhanced safety compared to pouch cells but requires more complex manufacturing equipment than cylindrical cells. Quality control and formation processes for prismatic cells may need to account for the unique thermal and electrical characteristics of the rectangular form factor, potentially requiring different testing protocols compared to cylindrical or pouch cell manufacturing.

After completion of the formation and acquiring electrical characteristics, batteries are either delivered as individual cells or modularized to suit (or fit) electric vehicle models. The pack process involves modularizing the battery cells and placing them into packs before final delivery.

The first step in the pack process is to bundle battery cells to build a module. First, several surfacecleaned battery cells are arranged in a "cell to cell" configuration, which are retained into a module case with adhesives. Then bus bars and leads are welded to connect to the cells with a laser welder, and the module build is completed with installing module top cover. Finally, a pack build is completed when these modules are placed into the battery pack enclosures and connected each other. These complete battery packs are then installed in many applications such as electric vehicles and various IT devices. The number of cells and modules in a battery pack may vary, depending on the battery cells and application models.

Because a battery pack contains multiple cells or modules, balancing and managing these cells is critical, especially to accurately measure state of charge and optimize battery life. Therefore, once a pack is assembled, the battery is monitored, and its performance maintained in optimal conditions using a control system called BMS (Battery Management System), which estimates the battery's charging state and life. The CMS (Cell Monitoring System) inside the BMS measures the cells' condition and performs balancing to ensure optimal battery performance, safety, and life.

"Cell balancing" refers to adjusting the voltage differences between two or more serially connected cells. For instance, if two cells connected in series reach voltages of 4.2V and 4.0V, respectively, during charging, cell balancing adjusts this 0.2v difference to equalize the voltage. Voltage imbalance can occur due to manufacturing or external factors, and it can affect battery capacity and life, posing risks of overcharging, over-discharging, and fire hazards. Hence, cell balancing is essential.

Mobility and IT battery products have a wide variety of applications in IT devices such as smartphones and laptops, as well as LEVs (Light Electric Vehicles), electric bicycles, power tools, and wireless earphones. In general, energy is difficult to store and is lost after being used. Energy Storage Systems (ESS) are systems that store and manage energy so the energy can be used more efficiently. ESS has applications in power plants, power transmission and distribution facilities, homes, factories, and businesses. Through a system that is coupled with renewable energy, ESS can increase the efficiency of renewable energy and reduce electricity costs. ESS can also be used as backup power to reduce damages from power outages. For example, ESS may include using a battery of a vehicle as a power source for a home during a grid power outage.

For example, solar modules installed on the roof of homes and ESS for uninterruptible power supply (UPS) in data centers store power and use the stored power during times of high demand or when electricity prices are high. In turn, ESS reduces damages from blackouts and saves electricity bills. Also, power plants can store and manage irregularly produced renewable energy, such as solar, wind, and hydroelectric power, which increases the efficiency of their use.

When used in conjunction with solar panel installations at home, ESS stores electricity produced by solar panels during daytime to be used at nighttime. A home battery may be a solution that can serve as an alternative energy source to reduce electricity costs and prepare for power outages. Installing ESS and solar power systems together generates power independently, increasing the self-consumption of power at home and reducing the overall electricity cost.

ESS for power grids, also commonly referred to as BESS, may be installed proximate to thermal power plants, solar and wind power plants, and substations. ESS for power grids has various applications in reducing power load, coupling with renewable power generation, and adjusting power frequency. Commercial ESS installed in commercial buildings such as offices, schools, factories, data centers, and the like may be used to reduce power load, or may be coupled with renewable power generation. ESS may include backup power solutions that protect facilities that require the constant supply of power, such as data centers and IT/telecommunications facilities. ESS may also be used to enable participation in an optimized energy marketplace, where excess power is sold back to the grid during peak hours and charged during off-peak hours. While BESS is ideal for use with renewable energy systems, BESS can store energy from many different sources, including energy generated by fossil fuels, hydropower, or any other power source that generates usable electricity.

An ESS is a system that stores electricity produced and supplies it when needed, thereby enhancing energy efficiency. It mainly includes four components: a battery, a power conversion system (PCS), a battery management system (BMS), and an energy management system (EMS). The PCS is a power conversion device that converts alternating current to direct current and vice versa. The BMS is a battery management system that typically monitors and/or controls one or more battery cells, packs, racks, and/or modules in the ESS, and includes safety features that stop charging and discharging if abnormalities in voltage, current, or temperature are detected. The EMS is a system that monitors the amount of electricity stored in the ESS and serves as a software responsible for the overall operation of the ESS.

There are three primary roles of ESS. First, it acts as an uninterrupted power supply in places where power outages must be avoided at all costs, such as hospitals and banks. In cases of power outages caused by typhoons or fires, it assists in power supply to prepare for large-scale blackout situations. Second, it stores generated energy and supplies it during peak power demand times. It helps to stabilize energy output by compensating for the inconsistent generation levels of new renewable energies such as solar and wind power. In homes, it can save on electricity bills by storing electricity during cheaper hours and using it during more expensive daytime hours. Third, it maintains the standard power frequency at 60 Hz in the power supply system, countering frequency fluctuations due to mismatches in supply and demand, thereby enhancing power quality.

A battery system may include controlling power to and from batteries and providing control signals. A battery energy storage system (BESS) may include a battery management system (BMS), a local energy management system (EMS), external data reporting, a power plant controller, a utility EMS, and fleet-level controls. The BMS may collect inputs from battery cells and modules, and may operate individual cells or groups of cells. The BMS may include a controller. The BMS may balance voltages in the battery cells, for example. The local EMS may collect information from the BMS, and may control the operations of the BMS at a system level. The EMS may determine available power and capacity of the BESS, for example. External data reporting may include components such as transformers, switchgear, or meters. The power plant controller may coordinate the local EMS with a supervisory system. The utility EMS may control an electrical grid connected to the BESS. The fleet-level controls may coordinate to operate multiple BESS’s at different locations. Communications between these components may be established wirelessly or through connected wires, depending on the system configuration and operational requirements.

BMS is a management system to monitor and control the status of batteries to operate them under optimal conditions. It measures the current, voltage, and temperature of batteries in Battery Electric Vehicles (BEVs) or Energy Storage Systems (ESS) with sensors, and identifies and controls potential concerns so that the batteries can maintain the highest performance possible. The location of the BMS can vary depending on the battery type or product.

The battery system includes the cell as the smallest unit, the module of a group of cells, and the pack of the final form of the battery. The role of BMS in a battery can be compared to that of a choir conductor. As a conductor sets the tone and tempo to combine different voices of the choir into a harmonious song, BMS tunes the current and voltage of each cell like a conductor.

BMS performs three main functions: monitoring, cell management, and control. Monitoring involves observing voltage, current, temperature, etc., through sensors in the battery system, and predicting state of charge (SoC) and the state of health (SoH) of the battery based on the data. Cell management refers to cell balancing, which reduces the voltage differences between battery cells to enhance energy efficiency and charging rate. Control is the process of regulating to prevent overcharging, overdischarging, and overcurrent in the battery. Ultimately, BMS plays a role in managing the life, performance, and safety of the battery, and as batteries continue to develop, BMS is also becoming more sophisticated and continues to evolve.

"C-rate" is a term one needs to know when dealing with fast charging speeds to the extent of acquiring special chargers and cables capable of rapid charging. Abbreviated from "current rate", the C-rate is a measure of the rate at which a battery is charged or discharged. It is also called "charge and discharge rates" and uses "C" as the unit, which is the abbreviation of "capacity". C-rate can be calculated by dividing the charging or discharging current (A) by the rated battery capacity (Ah). The standard C-rate is generally 1C.

Understanding the C-rate is very helpful when using batteries. First, the charge C-rates help users estimate how long it will take to fully charge their batteries. For example, when one sees a battery label that states, "Chargeable at 10C," it means the battery can be charged at a current of 10 times the battery capacity, and it takes at least 6 minutes to be completely charged.

On the other hand, the discharge C-rates help users predict the limits of product performance. For instance, a drone battery with a high discharge C-rate indicates a faster discharge rate, meaning it can perform complex maneuvers that require sudden high currents. Conversely, a low discharge C-rate could mean difficulty in performing high-performance actions that require high currents. Let us suppose that there is a drone battery with a discharge C-rate of 100C. The battery can supply a current of up to 100 times its capacity, but if the drone continues the move that requires that much power, it is discharged 100 times faster than the standard of an hour (3,600 seconds). Accordingly, it is discharged in just 36 seconds. As the use of batteries in our daily lives increases, and more products require fast charging or a sudden rush of high current, understanding the concept of C-rate will help us choose the right battery for each electronic device.

When we use portable electronic devices, we always check the battery's charge status. For instance, the battery icon on a phone shows percentages like 100%, 50%, 20%, etc. This indicator, showing how much percentage of the battery is left, is known as "SoC". Soc stands for "State of Charge". It represents the remaining battery capacity in percentage(%) which is the current usable battery capacity divided by the total capacity.

Accurate SoC measurement is a core competitive aspect for battery manufacturers. As such, there are various methods to measure SoC, including chemical, voltage, current integration, and pressure measurement methods. SoC is an element to provide convenience to users. Through SoC measurements, it is possible to determine how much longer the battery can be used more and users can determine when to charge and end the battery themselves, allowing them to use the device more efficiently. From the manufacturer's perspective, SoC is considered very important as it can enhance the stability of the battery. By setting the maximum charge of the battery lower than the highest point of the SoC and the minimum charge of the battery higher than the lowest point of the SoC, various problems such as safety issues due to overcharging and over-discharging of the battery can be prevented in advance. As a result, a more stable battery usage environment can be provided to users.

Batteries, like all other products, have a lifespan. The SoH (State of Health) is a useful indicator for the remaining life and the current state of batteries. It shows the battery's condition compared to its initial conditions at a glance. One can easily check the SoH on some smartphones, tablets, or laptops. Devices that do not provide SoH information, such as "maximum battery performance", can be assessed through specialized testing equipment. However, SoHs can vary even among batteries that have been used for the same period because battery life is affected by many factors, including user habits and the environment. In particular, if the electric vehicle battery is well managed, it is possible to drive the vehicle for 2 to 3 times longer than the manufacturer's warranty period with little decrease in SoH. SoH is referred to as "Maximum capacity" on some devices.

Recently, with many second-hand transactions taking place in real life, transactions of IT devices with batteries, such as smartphones and tablet PCs, are also increasing. At this time, SoH is a factor that must be checked to trade better products. Not only a second-hand transaction, but also an IT device with a built-in battery can be used more efficiently if the health status of the battery is checked with the SoH.

A cell is the basic unit of a battery. In devices requiring a lot of power, like electric vehicles, a battery pack contains numerous cells. However, even identical cells may develop voltage differences due to manufacturing processes or external factors. For example, when two cells connected in series are charged, the first cell could reach 4.2 V while the second cell stops at 4.0 V. Such imbalances between cells can affect battery capacity and life, and significantly increase the risk of safety issues due to overcharging and over-discharging. To prevent this, "cell balancing" is necessary.

Cell balancing adjusts and aligns the voltage differences between serially connected battery cells. It can be of two types: passive and active. Passive cell balancing dissipates the charging energy of a cell through a resistance to lower the cell voltage. In other words, it removes the charge from cells with more capacity by dissipating heat, making the charge of all cells uniform. While this method is simple and costeffective, it is less energy-efficient as it wastes excess voltage and can only be applied during charging.

Active cell balancing transfers the charging energy from cells with higher voltage to those with lower voltage. It redistributes the charge to equalize the voltage between cells by providing more capacity to cells with less capacity. Unlike passive cell balancing, which dissipates heat, active balancing redistributes energy, making it more energy-efficient and faster in charging. While active cell balancing can be applied during both charging and discharging, it involves more complex additional circuitry and is thus more costly. Cell balancing happens in the BMS (Battery Management System), where the CMU (Cell Monitoring Unit) in the BMS measures the state of the cells and starts balancing, enabling safer use of the battery.

Battery systems may increasingly be integrated into a wide range of mobile devices, including smartphones, laptops, electric vehicles (EVs), hybrid electric vehicles (HEVs), plug-in hybrid electric vehicles (PHEVs), and energy storage systems (ESS). As battery systems become more complex and operate under increasingly demanding conditions, maintaining reliable electrical connections between battery components may become a significant challenge.

One or more embodiments may address the real-time monitoring and detection of battery packs' power cable/bus bar intermittent/loose connection in embedded systems of EVs that are extremely resource-limited. Battery systems may typically include multiple battery cells or modules connected through various electrical connections, including bus bars, cables, and terminal connections. These connections may be subject to mechanical stress from factors such as temperature cycling, vibration, and normal wear over time.

One or more embodiments may recognize that there are types of pack loose connection and reasoning behind test protocols. Progressive increase in resistance may occur where temperature cycling starts to loosen the tightness, resistance slowly increases between few months to few years, current tries to bridge the gap, oxidation starts, resistance increases further, and the action continues. Observing the increase in resistance as connections are progressively loosened may provide valuable insights into the necessary thresholds.

The system may also address pulsating-like (intermittent) resistance where temperature cycling may start to loosen the tightness and EVs undergo many vibrations. Examples may include sudden start and stop (jostling), speed breakers, potholes, suspension system, electric motor, and other sources. Normal conditions to very loose conditions may be visualized as transitioning from normal to avalanche conditions. As the avalanche snowball effect grows, it may become increasingly hazardous. One or more embodiments may detect problems before they worsen.

One or more embodiments may manage memory by processing data in chunks, for example one iteration equals one-hundred rows. Voltage and temperature data may not be needed when significant signatures are present in certain phases. For implementation phases, current data and corresponding data state may be needed, where data state may have two states: 1 for valid, 0 for invalid.

The system may address resource comparison between EV and ESS systems. EVs may have extremely limited resources (e.g., storage capacity less than 200 KB and RAM of less than 40 KB), while ESS may have substantially greater resources (e.g., approximately 1 TB of storage and 8 GB to 32 GB of RAM).

One or more embodiments may implement code bases that include data preprocessing, feature extraction, and AI/ML models. Data preprocessing may involve removal of unwanted data and applying filters to remove noise. At lower current values, sensor error may be high, calibration may generally be done with loads ranging from between approximately 10% to approximately 100%, measurement may be affected by amplifier S/N ratio and other resistances in the system, and at high load, intermittent pack connection (IPC) may be more pronounced.

The system may perform feature extraction by averaging and finding individual deviations. Feature extraction may be like setting the right direction for models and may require domain knowledge (e.g., human expertise). Without feature extraction, there may be poor model performance, inefficient computational power, and large latency. With feature extraction, there may be improved model performance, computational efficiency, and very low latency.

One or more embodiments may implement memory management by avoiding dynamic memory allocation if possible, using static memory allocation to help decrease latency and provide better memory management with no overhead for allocation/deallocation, using fixed size buffers and queues, static variables, constant arrays, memory pooling, freeing any allocated memory immediately after use (every loop).

The system may utilize artificial neural networks with input layers having one neuron, first hidden layers having two neurons, second hidden layers having two neurons, and output layers having one neuron. Operation overviews of ANNs with weights and biases may get first inputs from first features, perform multiplication (dot product) with weights, add bias, apply activation functions (sigmoid), and repeat processes for all data points and across all features. One or more embodiments may implement ANN architectures with one or more predetermined weights. One or more embodiments may implement ANN architectures with one or more dynamic and/or adjustable weights.

Traditional battery management systems may face significant technical challenges in detecting intermittent or loose connections that develop gradually over time in battery pack assemblies. Conventional monitoring approaches may focus primarily on cell-level parameters such as voltage, current, and temperature, but may have limitations in identifying subtle connection degradation that manifests as progressive resistance increases or intermittent contact issues. These connection problems may present as minor current distribution variations or resistance fluctuations that occur before more obvious symptoms become apparent, making early detection difficult with standard BMS diagnostic capabilities. The technical drawbacks of existing systems may include an inability to detect connection issues during their initial stages, reliance on threshold-based alerts that may only trigger after significant degradation has occurred, and limited analytical capabilities for processing complex patterns in electrical measurement data that could indicate developing connection problems.

The ability to analyze patterns in electrical measurements and predict connection degradation may enhance battery system reliability and safety.

Modern battery systems may generate substantial amounts of operational data through continuous monitoring of electrical parameters. This data may contain information about system behavior that may be analyzed to identify anomalous patterns indicative of connection issues. Advanced data analysis techniques, including machine learning approaches, may offer possibilities for processing this information to detect subtle indicators of connection degradation that might not be readily apparent through conventional monitoring methods.

One or more embodiments may provide a technical improvement through implementation of machine learning-based predictive analysis that processes current sensor data from multiple battery packs to identify anomalous patterns indicative of loose or degraded connections. The system may utilize feature extraction techniques that determine average current values across battery packs and determine individual deviations from these averages, enabling detection of subtle current distribution irregularities that may indicate connection issues. This approach may represent an improvement over conventional methods by analyzing data patterns in real-time using neural networks or logistic regression models that can identify intermittent resistance conditions before they progress to more severe failure states. The technical solution may operate within resource-constrained embedded environments typical of electric vehicle systems, processing data in manageable chunks while maintaining low computational overhead and memory usage, thereby providing early warning capabilities that may prevent more serious connection failures and enhance overall battery system reliability and safety.

One or more embodiments may provide technical improvements to battery system hardware components and operational performance through implementation of machine learning-based loose connection detection. The battery management system controller may operate more effectively by utilizing predictive analytics that process current sensor data in real-time, enabling early identification of connection degradation before traditional threshold-based monitoring systems would detect issues. Current sensors may benefit from improved signal processing through feature extraction techniques that determine average current values across multiple battery packs and determine individual deviations, enhancing the accuracy and reliability of current measurements for detecting subtle distribution irregularities.

The software may reduce hardware stress by preventing progression of loose connections that could otherwise lead to increased resistance, heat generation, and potential arcing conditions. By detecting intermittent resistance conditions in their early stages, the system may prevent thermal stress on bus bars, connectors, and adjacent battery cells that would occur as connection resistance increases over time. The early warning capabilities may enable proactive maintenance interventions that prevent more severe failure states, thereby reducing mechanical stress on connection hardware and extending the operational lifetime of electrical connections within the battery system.

Battery cells, modules, and packs may experience improved lifetime and reliability through prevention of unbalanced current distribution that can occur when loose connections develop. The system may detect current distribution anomalies that indicate one or more battery packs are not contributing equally to system operation, preventing overloading of properly connected packs and reducing stress on individual cells. Connection hardware including bus bars, terminals, and fasteners may benefit from extended service life through early detection and remediation of loosening conditions before oxidation and progressive resistance increases cause permanent damage.

The software may enable battery hardware to operate within safer operational parameters by providing early detection of conditions that could lead to thermal runaway or electrical faults. The machine learning models may identify patterns in current sensor data that indicate developing connection issues, allowing the system to implement protective measures such as reduced charging rates or load limitations before hardware reaches critical failure thresholds. This capability may allow continued operation under monitored conditions while maintenance is scheduled, rather than requiring immediate system shutdown.

Energy consumption of the hardware system may be reduced through prevention of resistive losses that occur when connections degrade. Loose connections may create additional resistance in the electrical path, leading to energy dissipation as heat and reduced system efficiency. By detecting and addressing connection issues early, the system may maintain optimal electrical conductivity and reduce energy losses. The software implementation may also reduce energy consumption by operating efficiently within resource-constrained embedded environments, processing data in manageable chunks while maintaining low computational overhead.

Cost reduction may be achieved by allowing continued use of existing battery hardware while providing enhanced monitoring capabilities that extend service intervals and prevent catastrophic failures. The system may reduce the need for frequent physical inspections of connection hardware by providing continuous monitoring and early warning of developing issues. This approach may allow maintenance to be scheduled based on actual condition rather than predetermined intervals, optimizing maintenance costs while maintaining system reliability.

The BMS controller may experience improved functioning through implementation of efficient data processing algorithms that operate within extremely limited resources typical of electric vehicle embedded systems. The software may reduce computational load by processing current sensor data in one-second intervals using static memory allocation techniques that avoid dynamic memory allocation overhead. Memory usage may be optimized through use of fixed-size buffers, static variables, and constant arrays, with RAM usage maintained at approximately 50% to 54% of available capacity.

Computational efficiency may be enhanced through feature extraction techniques that reduce the dimensionality of sensor data while preserving relevant information for anomaly detection. The system may achieve execution times of approximately 13.4 milliseconds per processing cycle, enabling real-time analysis without impacting other BMS functions. The machine learning models may be implemented using manual parameter extraction and deployment without requiring dedicated libraries, reducing memory footprint and computational overhead.

Fault tolerance and reliability of the controller may be improved through implementation of robust data validation techniques that identify and remove invalid sensor readings based on data state variables. The system may apply moving average filters to reduce noise in current measurements and implement threshold-based filtering to exclude measurements taken at low current values where sensor accuracy may be compromised. These preprocessing techniques may enhance the reliability of subsequent analysis and reduce the likelihood of false positive detections.

Measurement accuracy may be improved through advanced signal processing techniques that analyze current distribution patterns across multiple battery packs. The system may compensate for sensor variations by determining deviations from average current values, providing a normalized basis for comparison that may be less sensitive to individual sensor calibration differences. The feature extraction process may enhance the resolution of connection monitoring by detecting subtle patterns in current distribution that would not be apparent through individual sensor readings.

Earlier and more accurate fault detection may be achieved through machine learning models that may identify intermittent resistance patterns before they progress to more obvious failure modes. The system may detect loose connections during their initial development stages, months, or years before traditional monitoring systems would identify the issue. This early detection capability may prevent progression to more severe conditions such as arcing, overheating, or complete connection failure.

Charging and discharging efficiency may be improved by maintaining optimal current distribution across all battery packs through early detection of connection issues that could cause unbalanced loading. The system may identify when one or more packs are not contributing equally to system operation, allowing corrective measures to be implemented before efficiency is significantly impacted. Balanced current distribution may optimize energy transfer and reduce losses associated with uneven loading of parallel-connected battery packs.

Battery pack cycle life and calendar life may be extended through prevention of stress conditions that occur when loose connections cause unbalanced current distribution. The system may detect conditions where properly connected packs are carrying disproportionate current loads due to increased resistance in other connection paths, preventing accelerated degradation of overloaded cells. Early intervention may prevent the cascading effects of connection degradation that could otherwise lead to premature battery replacement.

Safety under extreme conditions may be enhanced through continuous monitoring capabilities that can detect developing connection issues during high-current operations such as fast charging or high-power discharge events. The system may identify intermittent resistance conditions that become more pronounced under high-load conditions, providing early warning of potential safety hazards. The machine learning models may be trained to recognize patterns associated with different types of connection degradation, enabling appropriate responses based on the specific nature of detected anomalies.

The software may improve predictive modeling of connection degradation by analyzing historical patterns in current sensor data to identify trends that precede connection failures. The machine learning models may provide insights into the progression of connection issues, enabling more accurate predictions of maintenance requirements and remaining service life of connection hardware. This predictive capability may support condition-based maintenance strategies that optimize both safety and operational costs.

Interoperability with other vehicle systems may be improved through standardized diagnostic outputs that can be integrated with fleet management systems, telematics platforms, and maintenance scheduling applications. The system may provide structured data about connection health that can be used by external systems for predictive maintenance planning and operational optimization. Communication robustness may be enhanced through efficient data processing that reduces the volume of diagnostic information while preserving relevant details about system condition.

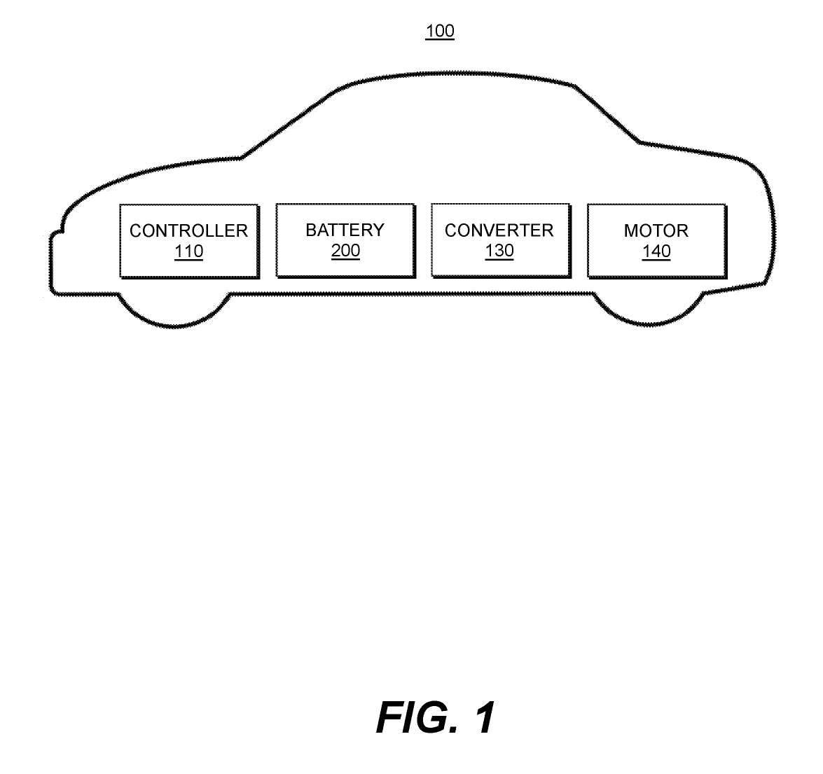

FIG. 1 depicts an exemplary system infrastructure for a vehicle, according to one or more embodiments. Vehicle 100 may include controller 110, battery 200, power converter 130, and motor 140. Controller 110 may control an operation of one or more of power converter 130 or motor 140. Power converter 130 may be connected to one or more of battery 200 or motor 140. Power converter 130 may convert power from battery 200 to rotate motor 140. Power converter 130 may convert power from battery 200 to be used as an ESS (e.g., used with an ESS, such as in conjunction with solar panels and a grid connection). )Power converter 130 may charge battery 200. Battery 200 may include one or more batteries. Battery 200 may include individual battery cells, and a controller configured to control one or more of a charging of the battery 200 or a discharging of the battery 200. Vehicle 100 may include diesel powered vehicles, gasoline powered vehicles, hydrogen powered vehicles, electric powered vehicles, or hybrid vehicles.

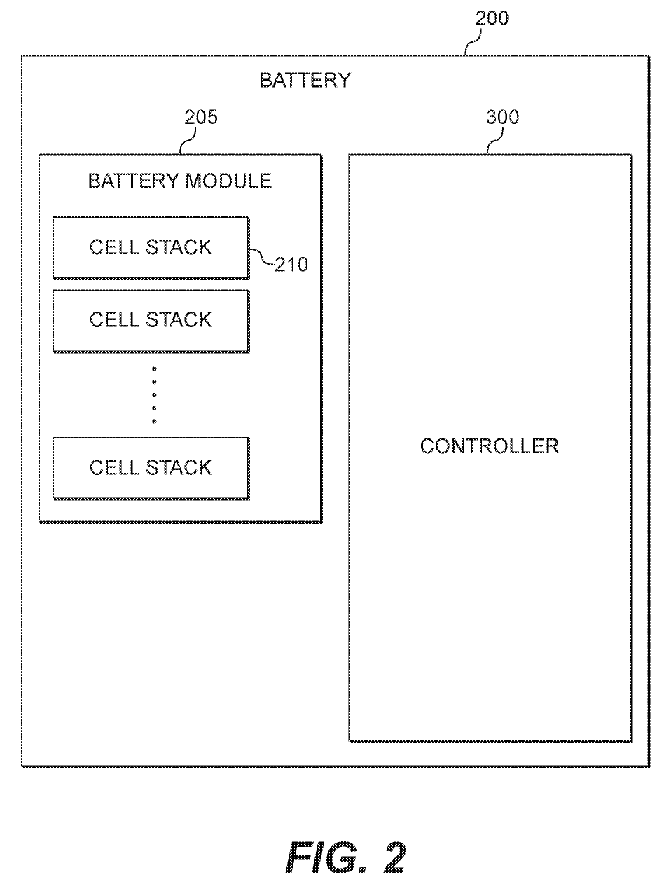

Battery 200 (see FIG. 2) may further include a control unit such as a battery management system (BMS) for each battery module or group. For example, each battery module 205 may include a pack BMS. A battery module 205 including a pack BMS may be referred to as a battery pack. Alternatively, a battery pack assembly may include one or more battery cells with a module-less design, such as a direct cell-to-pack design, for example.

FIG. 2 depicts a battery, according to one or more embodiments. Battery 200 may include a battery module 205 and controller 300. Battery module 205 may include a plurality of cell stacks, including cell stack 210.

Battery 200 may include a battery pack. Battery 200 may include an overcharge prevention apparatus. Overcharge prevention apparatus may include a voltage measuring unit, a current regulating unit, a controller 300, and optionally may further include at least one of a disconnecting unit, a current measuring unit, and a cooling unit. Additionally, when the overcharge prevention apparatus includes a disconnecting unit, a discharge inducing unit may be included.

The plurality of cell stacks, which may include cell stack 210, may be connected in series and installed on a high current path between two power terminals of battery 200. A voltage measuring unit may measure the voltage of each cell stack 210, and may generate a first monitoring signal indicating the measured voltage. The first monitoring signal generated by the voltage measuring unit may be transmitted to the controller. The current regulating unit may be configured to selectively provide each cell stack 210 with bypass paths connected in parallel. Current regulating unit may provide bypass paths individually to the plurality of cell stacks, which may include for example cell stack 210.

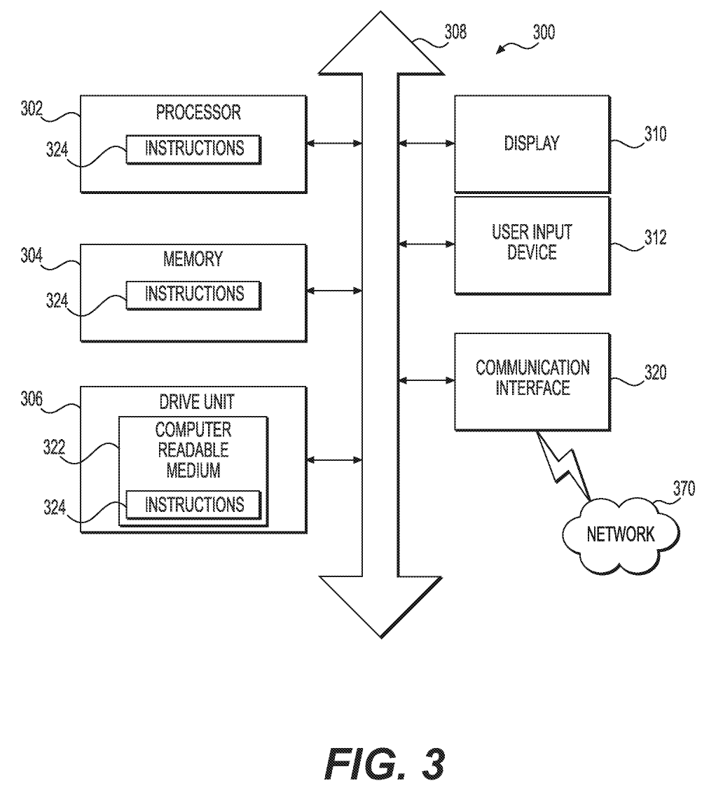

FIG. 3 depicts a controller, according to one or more embodiments. FIG. 3 and the following discussion provide a brief, general description of a suitable computing environment in which the present disclosure may be implemented. In one embodiment, any of the disclosed systems, methods, and/or graphical user interfaces may be executed by or implemented by a computing system consistent with or similar to that depicted in FIG. 3. Although not required, aspects of the present disclosure are described in the context of computer-executable instructions, such as routines executed by a data processing device, e.g., a server computer, wireless device, and/or personal computer. Those skilled in the relevant art will appreciate that aspects of the present disclosure can be practiced with other communications, data processing, or computer system configurations, including: Internet appliances, hand-held devices (including personal digital assistants (“PDAs”)), wearable computers, all manner of cellular or mobile phones (including Voice over IP (“VoIP”) phones), dumb terminals, media players, gaming devices, virtual reality devices, multi-processor systems, microprocessor-based or programmable consumer electronics, set-top boxes, network PCs, mini-computers, mainframe computers, and the like. Indeed, the terms “computer,” “server,” and the like, are generally used interchangeably herein, and refer to any of the above devices and systems, as well as any data processor.

Aspects of the present disclosure may be embodied in a special purpose computer and/or data processor that is specifically programmed, configured, and/or constructed to perform one or more of the computer-executable instructions explained in detail herein. While aspects of the present disclosure, such as certain functions, are described as being performed exclusively on a single device, the present disclosure may also be practiced in distributed environments where functions or modules are shared among disparate processing devices, which are linked through a communications network, such as a Local Area Network (“LAN”), Wide Area Network (“WAN”), and/or the Internet. Similarly, techniques presented herein as involving multiple devices may be implemented in a single device. In a distributed computing environment, program modules may be located in both local and/or remote memory storage devices.

Aspects of the present disclosure may be stored and/or distributed on non-transitory computer-readable media, including magnetically or optically readable computer discs, hard-wired or preprogrammed chips (e.g., EEPROM semiconductor chips), nanotechnology memory, biological memory, or other data storage media. Alternatively, computer implemented instructions, data structures, screen displays, and other data under aspects of the present disclosure may be distributed over the Internet and/or over other networks (including wireless networks), on a propagated signal on a propagation medium (e.g., an electromagnetic wave(s), a sound wave, etc.) over a period of time, and/or they may be provided on any analog or digital network (packet switched, circuit switched, or other scheme).

The controller 300 may include a set of instructions that can be executed to cause the controller 300 to perform any one or more of the methods or computer-based functions disclosed herein. The controller 300 may operate as a standalone device or may be connected, e.g., using a network, to other computer systems or peripheral devices.

In a networked deployment, the controller 300 may operate in the capacity of a server or as a client in a server-client user network environment, or as a peer computer system in a peer-to-peer (or distributed) network environment. The controller 300 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular implementation, the controller 300 can be implemented using electronic devices that provide voice, video, or data communication. Further, while the controller 300 is illustrated as a single system, the term “system” shall also be taken to include any collection of systems or sub-systems that individually or jointly execute a set, or multiple sets, of instructions to perform one or more computer functions.

As illustrated in FIG. 3, the controller 300 may include a processor 302, e.g., a central processing unit (CPU), a graphics processing unit (GPU), or both. The processor 302 may be a component in a variety of systems. For example, the processor 302 may be part of a standard computer. The processor 302 may be one or more general processors, digital signal processors, application specific integrated circuits, field programmable gate arrays, servers, networks, digital circuits, analog circuits, combinations thereof, or other now known or later developed devices for analyzing and processing data. The processor 302 may implement a software program, such as code generated manually (i.e., programmed).

The controller 300 may include a memory 304 that can communicate via a bus 308. The memory 304 may be a main memory, a static memory, or a dynamic memory. The memory 304 may include, but is not limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one implementation, the memory 304 includes a cache or random-access memory for the processor 302. In alternative implementations, the memory 304 is separate from the processor 302, such as a cache memory of a processor, the system memory, or other memory. The memory 304 may be an external storage device or database for storing data. Examples include a hard drive, compact disc (“CD”), digital video disc (“DVD”), memory card, memory stick, floppy disc, universal serial bus (“USB”) memory device, or any other device operative to store data. The memory 304 is operable to store instructions executable by the processor 302. The functions, acts or tasks illustrated in the figures or described herein may be performed by the processor 302 executing the instructions stored in the memory 304. The functions, acts or tasks are independent of the particular type of instructions set, storage media, processor or processing strategy and may be performed by software, hardware, integrated circuits, firm-ware, micro-code, and the like, operating alone or in combination. Likewise, processing strategies may include multiprocessing, multitasking, parallel processing, and the like.

As shown, the controller 300 may further include a display 310, such as a liquid crystal display (LCD), an organic light emitting diode (OLED), a flat panel display, a solid-state display, a cathode ray tube (CRT), a projector, a printer or other now known or later developed display device for outputting determined information. The display 310 may act as an interface for the user to see the functioning of the processor 302, or specifically as an interface with the software stored in the memory 304 or in the drive unit 306.

Additionally or alternatively, the controller 300 may include an input device 312 configured to allow a user to interact with any of the components of controller 300. The input device 312 may be a number pad, a keyboard, or a cursor control device, such as a mouse, or a joystick, touch screen display, remote control, or any other device operative to interact with the controller 300.

The controller 300 may also or alternatively include drive unit 306 implemented as a disk or optical drive. The drive unit 306 may include a computer-readable medium 322 in which one or more sets of the instructions 324, e.g., software, can be embedded. Further, the instructions 324 may embody one or more of the methods or logic as described herein. The instructions 324 may reside completely or partially within the memory 304 and/or within the processor 302 during execution by the controller 300. The memory 304 and the processor 302 also may include computer-readable media as discussed above.

In some systems, a computer-readable medium 322 includes instructions 324 or receives and executes instructions 324 responsive to a propagated signal so that a device connected to a network 370 can communicate voice, video, audio, images, or any other data over the network 370. Further, the instructions 324 may be transmitted or received over the network 370 via a communication port or interface 320, and/or using a bus 308. The communication port or interface 320 may be a part of the processor 302 or may be a separate component. The communication port or interface 320 may be created in software or may be a physical connection in hardware. The communication port or interface 320 may be configured to connect with a network 370, external media, the display 310, or any other components in controller 300, or combinations thereof. The connection with the network 370 may be a physical connection, such as a wired Ethernet connection or may be established wirelessly as discussed below. Likewise, the additional connections with other components of the controller 300 may be physical connections or may be established wirelessly. The network 370 may alternatively be directly connected to a bus 308.

While the computer-readable medium 322 is shown to be a single medium, the term "computer-readable medium" may include a single medium or multiple media, such as a centralized or distributed database, and/or associated caches and servers that store one or more sets of instructions. The term "computer-readable medium" may also include any medium that is capable of storing, encoding, or carrying a set of instructions for execution by a processor or that cause a computer system to perform any one or more of the methods or operations disclosed herein. The computer-readable medium 322 may be non-transitory, and may be tangible.

The computer-readable medium 322 can include a solid-state memory such as a memory card or other package that houses one or more non-volatile read-only memories. The computer-readable medium 322 can be a random-access memory or other volatile re-writable memory. Additionally or alternatively, the computer-readable medium 322 can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the disclosure is considered to include any one or more of a computer-readable medium or a distribution medium and other equivalents and successor media, in which data or instructions may be stored.

In an alternative implementation, dedicated hardware implementations, such as application specific integrated circuits, programmable logic arrays and other hardware devices, can be constructed to implement one or more of the methods described herein. Applications that may include the apparatus and systems of various implementations can broadly include a variety of electronic and computer systems. One or more implementations described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

The controller 300 may be connected to a network 370. The network 370 may define one or more networks including wired or wireless networks. The wireless network may be a cellular telephone network, an 802.11, 802.16, 802.20, or WiMAX network. Further, such networks may include a public network, such as the Internet, a private network, such as an intranet, or combinations thereof, and may utilize a variety of networking protocols now available or later developed including, but not limited to TCP/IP based networking protocols. The network 370 may include wide area networks (WAN), such as the Internet, local area networks (LAN), campus area networks, metropolitan area networks, a direct connection such as through a Universal Serial Bus (USB) port, or any other networks that may allow for data communication. The network 370 may be configured to couple one computing device to another computing device to enable communication of data between the devices. The network 370 may generally be enabled to employ any form of machine-readable media for communicating information from one device to another. The network 370 may include communication methods by which information may travel between computing devices. The network 370 may be divided into sub-networks. The sub-networks may allow access to all of the other components connected thereto or the sub-networks may restrict access between the components. The network 370 may be regarded as a public or private network connection and may include, for example, a virtual private network or an encryption or other security mechanism employed over the public Internet, or the like.

In accordance with various implementations of the present disclosure, the methods described herein may be implemented by software programs executable by a computer system. Further, in an exemplary, non-limited implementation, implementations can include distributed processing, component/object distributed processing, and parallel processing. Alternatively, virtual computer system processing can be constructed to implement one or more of the methods or functionality as described herein.

Although the present specification describes components and functions that may be implemented in particular implementations with reference to particular standards and protocols, the disclosure is not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

It will be understood that the steps of methods discussed are performed in one embodiment by an appropriate processor (or processors) of a processing (i.e., computer) system executing instructions (computer-readable code) stored in storage. It will also be understood that the disclosure is not limited to any particular implementation or programming technique and that the disclosure may be implemented using any appropriate techniques for implementing the functionality described herein. The disclosure is not limited to any particular programming language or operating system.

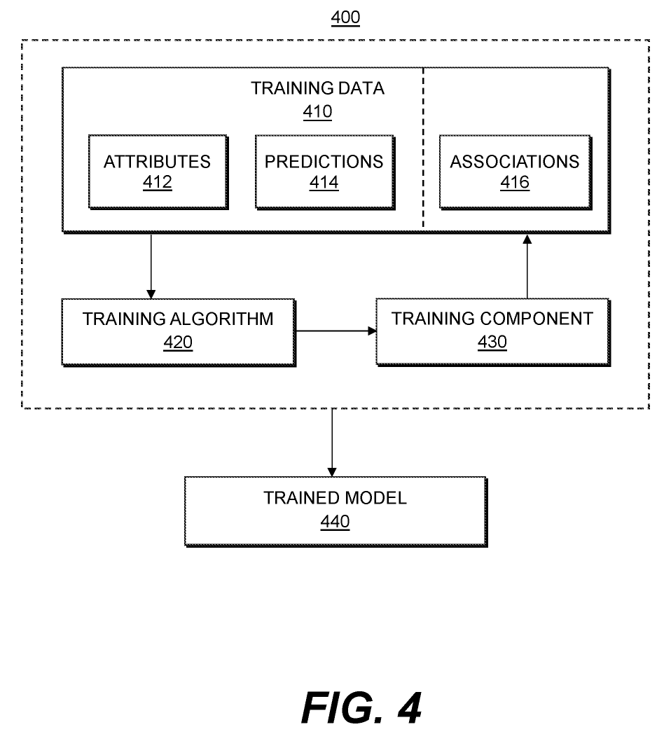

FIG. 4 depicts a flow diagram for training a machine learning model, according to one or more embodiments. As disclosed herein, one or more implementations disclosed herein may be applied by using a machine learning model. A machine learning model as disclosed herein may be trained using one or more components or operations. As depicted in flow diagram 400 of FIG. 4, training data 410 may include one or more of attributes 412 and predictions 414 related to a machine learning model to be trained. The attributes 412 may be from any applicable source including a component, attribute of a component, extracted feature, or set shown in the figures provided herein. The predictions 414 may be included for machine learning models generated based on supervised or semi-supervised training. An unsupervised machine learning model might not be trained using predictions 414. Predictions 414 may include known or desired outputs for future inputs similar to or in the same category as attributes 412 that do not have corresponding known outputs.

The training data 410 and a training algorithm 420 may be provided to a training component 430 that may apply the training data 410 to the training algorithm 420 to generate a trained machine learning model 440. The training component 430 may be provided associations 416 that compare a previous output of the corresponding machine learning model to apply the previous result to re-train the machine learning model. The associations 416 may be used by the training component 430 to update the corresponding machine learning model. The training algorithm 420 may utilize machine learning networks and/or models including, but not limited to a deep learning network such as Deep Neural Networks (DNN), Convolutional Neural Networks (CNN), Fully Convolutional Networks (FCN) and Recurrent Neural Networks (RCN), probabilistic models such as Bayesian Networks and Graphical Models, and/or discriminative models such as Decision Forests and maximum margin methods, or the like.

A machine learning model disclosed herein may be trained by adjusting one or more weights, layers, and/or biases during a training phase. During the training phase, historical or simulated data may be provided as inputs to the model. The model may adjust one or more of its weights, layers, and/or biases based on such historical or simulated information. The adjusted weights, layers, and/or biases may be configured in a production version of the machine learning model (e.g., a trained model) based on the training. Once trained, the machine learning model may output machine learning model outputs in accordance with the subject matter disclosed herein. One or more machine learning models disclosed herein may continuously update based on feedback associated with use or implementation of the machine learning model outputs.

FIG. 4 depicts a flow diagram for training a machine learning model, according to one or more embodiments. As disclosed herein, one or more implementations disclosed herein may be applied by using a machine learning model. A machine learning model as disclosed herein may be trained using one or more components or operations. As depicted in flow diagram 400 of FIG. 4, training data 410 may include one or more of attributes 412 and predictions 414 related to a machine learning model to be trained. The attributes 412 may be from any applicable source including a component, attribute of a component, extracted feature, or set shown in the figures provided herein. The predictions 414 may be included for machine learning models generated based on supervised or semi-supervised training. An unsupervised machine learning model might not be trained using predictions 414. Predictions 414 may include known or desired outputs for future inputs similar to or in the same category as attributes 412 that do not have corresponding known outputs.

The training data 410 and a training algorithm 420 may be provided to a training component 430 that may apply the training data 410 to the training algorithm 420 to generate a trained machine learning model 440. The training component 430 may be provided associations 416 that compare a previous output of the corresponding machine learning model to apply the previous result to re-train the machine learning model. The associations 416 may be used by the training component 430 to update the corresponding machine learning model. The training algorithm 420 may utilize machine learning networks and/or models including, but not limited to a deep learning network such as Deep Neural Networks (DNN), Convolutional Neural Networks (CNN), Fully Convolutional Networks (FCN) and Recurrent Neural Networks (RCN), probabilistic models such as Bayesian Networks and Graphical Models, and/or discriminative models such as Decision Forests and maximum margin methods, or the like.

A machine learning model disclosed herein may be trained by adjusting one or more weights, layers, and/or biases during a training phase. During the training phase, historical or simulated data may be provided as inputs to the model. The model may adjust one or more of its weights, layers, and/or biases based on such historical or simulated information. The adjusted weights, layers, and/or biases may be configured in a production version of the machine learning model (e.g., a trained model) based on the training. Once trained, the machine learning model may output machine learning model outputs in accordance with the subject matter disclosed herein. One or more machine learning models disclosed herein may continuously update based on feedback associated with use or implementation of the machine learning model outputs.

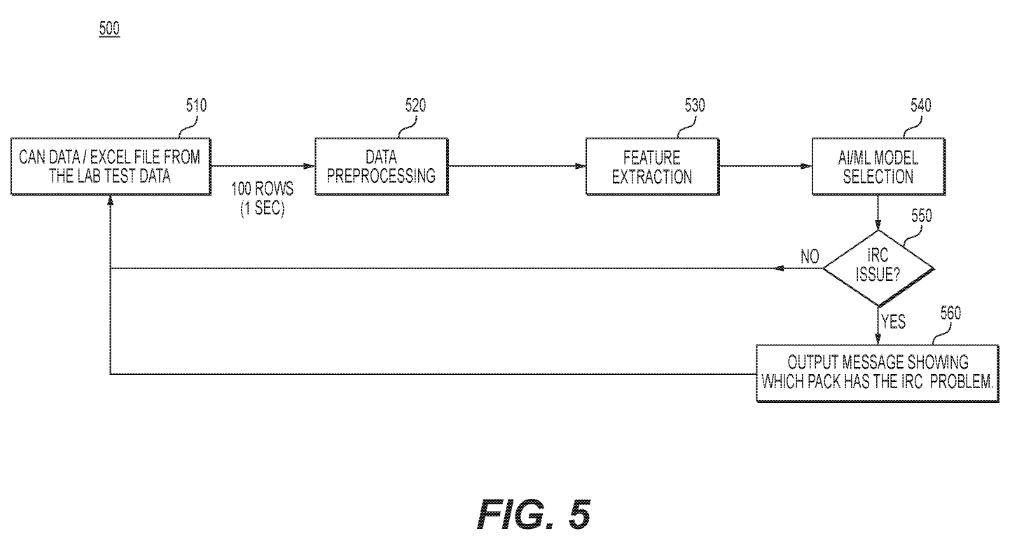

FIG. 5 depicts a flow diagram for detecting loose connections in a battery system, according to one or more embodiments. The method 500 illustrates a systematic process for detecting loose connections in battery systems through machine learning-based analysis. The method 500 may provide an approach that processes battery system data through multiple sequential stages to identify intermittent resistance conditions or loose connections that may develop over time in battery pack assemblies. The method 500 may begin with an operation 510 where data is obtained from a lab test. The operation 510 may involve collecting electrical measurement data from battery systems under controlled test conditions, including current sensor readings from multiple battery packs operating under various connection states. The data obtained during the operation 510 may include measurements taken at predetermined intervals, for example 10ms sampling intervals, to capture detailed electrical characteristics of the battery system during operation.

Following the operation 510, the method 500 may proceed to a data preprocessing 520 stage. The data preprocessing 520 may involve multiple data conditioning operations to prepare the collected data for subsequent analysis. During the data preprocessing 520, the controller 300 may remove invalid data from the data set based on one or more data state variables. The data preprocessing 520 may also include filtering the data set using a moving average filter which may reduce noise and improve signal quality. The data preprocessing 520 may further involve removing current measurements that do not exceed a threshold value (e.g., approximately 10%) of the maximum load of the battery system, as measurements at lower current values may have reduced accuracy due to sensor limitations.

The method 500 may then advance to a feature extraction 530 stage following the data preprocessing 520. The feature extraction 530 may involve determining statistical characteristics of the preprocessed data to identify patterns indicative of connection anomalies. During the feature extraction 530, the controller 300 may average current values across multiple battery packs and determine deviations of individual current measurements from the determined averages. The feature extraction 530 may generate feature vectors that represent the electrical characteristics of the battery system in a format suitable for machine learning analysis.

After the feature extraction 530, the method 500 may proceed to an AI/ML model selection 540 stage. The AI/ML model selection 540 may involve applying a machine learning model to the extracted features to analyze patterns in the data. During the AI/ML model selection 540, the controller 300 may apply the machine learning model to the data set to generate a determination that the data set meets one or more threshold values associated with the battery system having a loose connection. The AI/ML model selection 540 may utilize neural networks or logistic regression models that have been trained to recognize current distribution patterns associated with loose or degraded electrical connections.

The method 500 may include a decision point represented by an IPC issue 550 determination. The IPC issue 550 may evaluate whether the machine learning analysis has identified abnormal current patterns indicating progressive loosening of electrical connections. The IPC issue 550 determination may compare the output of the machine learning model against predetermined threshold values to determine whether a loose connection condition is present in the battery system.

Based on the IPC issue 550 determination, the method 500 may proceed to an operation 560 that outputs results of the analysis. If the IPC issue 550 indicates that a loose connection has been detected, the operation 560 may generate a notification based on the determination that the data set meets the one or more threshold values. The operation 560 may output the notification, wherein the notification includes one or more indications or one or more predictions of a loose connection within each of the one or more batteries of the battery system. The operation 560 may specifically identify which battery pack has an IPC problem, providing targeted diagnostic information for maintenance personnel.

If the IPC issue 550 determination indicates that no loose connection is present, the operation 560 may output a message indicating that no IPC problem has been detected in the battery system. The operation 560 may provide confirmation that all electrical connections are operating within normal parameters based on the machine learning analysis.

The controller 300 may implement the method 500 with specific performance characteristics to operate within resource-constrained embedded environments. The controller 300 may process data in chunks of 100 rows representing approximately one second of data, enabling manageable memory usage while maintaining real-time analysis capabilities. The controller 300 may maintain execution time constraints of less than 10ms per analysis cycle to ensure that the loose connection detection process does not interfere with other battery management functions. The controller 300 may operate with RAM usage maintained at a predetermined level of available memory, providing efficient resource utilization while preserving system stability and responsiveness.

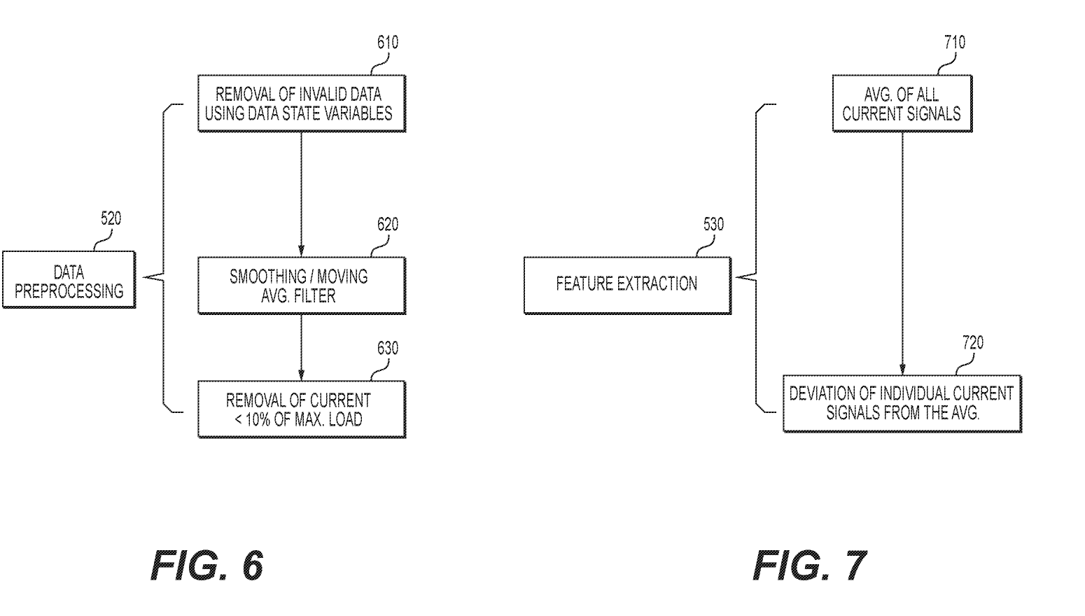

FIG. 6 depicts a flowchart illustrating data preprocessing for detecting loose connections in a battery system of FIG. 5, according to one or more embodiments. Referring to FIG. 6, the data preprocessing 520 may include multiple sequential operations that condition the collected battery system data for subsequent machine learning analysis. The data preprocessing 520 may begin with an operation 610 that removes invalid data using data-state variables. The operation 610 may identify and filter invalid data based on data state variables that indicate the validity of sensor measurements. The controller 300 may implement the operation 610 by evaluating data state variables associated with each current measurement, where data state variables may include binary indicators with values of 1 for valid measurements and 0 for invalid measurements. The operation 610 may remove invalid data from the data set based on one or more data state variables, ensuring that subsequent processing operations utilize only reliable sensor readings.

The data preprocessing 520 may continue with an operation 620 that may apply a smoothing or moving average filter to the data set. The operation 620 may apply a moving average filter to reduce noise and improve signal quality in the current measurements. The controller 300 may implement the operation 620 by determining a moving average across a predetermined window of current measurements, where the moving average may be computed using a sliding window approach that processes sequential data points. The operation 620 may filter the data set using a moving average filter, which may enhance the accuracy of current measurements by reducing the impact of transient noise and sensor variations that could otherwise affect the reliability of loose connection detection.

Following the operation 620, the data preprocessing 520 may proceed to an operation 630 that may remove current values less than a predetermined threshold value (e.g., approximately 10% of maximum load). The operation 630 may filter out low current measurements below the predetermined threshold value, as sensor accuracy may be compromised at lower current values. The controller 300 may implement the operation 630 by comparing each current measurement against the predetermined threshold value, for example determined as approximately 10% of the maximum load capacity of the battery system. The operation 630 may remove current measurements that do not exceed the predetermined threshold value, as calibration may generally be performed with loads ranging from approximately 10% to approximately 100% of maximum capacity, and measurements at lower current values may be affected by amplifier signal-to-noise ratio and other resistances in the system.

With continued reference to FIG. 6, the controller 300 may implement data sampling at 10ms intervals with processing occurring in chunks of 100 rows representing one second of data. The controller 300 may collect current measurements from multiple battery modules at predetermined intervals during vehicle operation, enabling synchronization of current measurements across each of the connected battery modules to enable comparative analysis. The controller 300 may store current distribution data to maintain a rolling window of recent measurements, providing a continuous data stream for real-time analysis while managing memory usage within the constraints of embedded systems.

The data preprocessing 520 may provide computational efficiencies by reducing the volume of data that requires processing by the machine learning model while maintaining the integrity of information needed for loose connection detection. For example, the operation 610 may remove invalid data points that would otherwise consume computational resources without contributing meaningful information to the analysis. The operation 630 may filter out current measurements below the predetermined threshold value, which may eliminate approximately 10-20% of low-accuracy data points that could introduce noise into the machine learning analysis. This preprocessing approach may reduce the computational load on the controller 300 by processing fewer data points while focusing analysis on measurements where sensor accuracy is highest, enabling the system to operate within the resource constraints of embedded battery management systems with RAM usage maintained at approximately 54% of available capacity.

The preprocessing operations may also enhance measurement accuracy by applying the moving average filter in operation 620, which may smooth transient variations and reduce the impact of electrical noise that could otherwise lead to false positive detections of loose connections. The controller 300 may implement this filtering approach to improve the signal-to-noise ratio of current measurements, enabling more reliable identification of subtle current distribution patterns that indicate developing connection issues. By combining data validation, noise reduction, and threshold-based filtering, the preprocessing stage may transform raw sensor data into a refined dataset that enhances the performance of subsequent machine learning analysis while reducing computational requirements, thereby integrating the data processing operations into a practical application that improves the functioning of battery monitoring technology rather than merely applying abstract mathematical concepts to generic data processing tasks.

FIG. 7 depicts a flowchart showing feature extraction for detecting loose connections in a battery system of FIG. 5, according to one or more embodiments. As shown in FIG. 7, the feature extraction 530 may include sequential operations that transform the preprocessed current data into statistical features suitable for machine learning analysis. The feature extraction 530 may begin with an operation 710 that may determine an average of all current signals. The operation 710 may compute a statistical average across current measurements to establish a baseline reference value for comparison with individual current readings. The controller 300 may implement the operation 710 by averaging one or more sensed current values associated with one or more batteries of the battery system, where the averaging process may be performed across multiple battery modules during one or more time intervals to provide a representative baseline current value.

The feature extraction 530 may continue with an operation 720 that may determine deviation of individual current signals from the average. The operation 720 may determine absolute deviations of individual current values from the average to identify anomalous current distribution patterns that may indicate loose connections. The controller 300 may implement the operation 720 by determining a deviation for each of the one or more sensed current values based on the average one or more sensed current values determined during the operation 710. The operation 720 may determine an absolute deviation of individual current values from the average current value of the one or more sensed current values, providing a normalized measure of how individual battery modules deviate from expected current distribution patterns.

The controller 300 may determine one or more statistical deviation currents for each of the one or more connected battery modules from an average current value during the operation 720. The controller 300 may detect current imbalances for each of the connected battery modules based on the statistical deviation currents, enabling identification of modules that may be experiencing connection issues. The controller 300 may identify one or more deviations that exceed a predetermined deviation threshold, where the predetermined deviation threshold may be established based on historical data and system characteristics to distinguish between normal current variations and anomalous patterns indicative of loose connections.

The controller 300 may generate a feature vector based on the one or more deviations for input into the machine learning model. The feature vector may represent the current distribution characteristics of the battery system in a format suitable for machine learning analysis, where the feature vector may include statistical measures of current deviations that capture patterns associated with connection degradation. The controller 300 may determine a first feature based on the deviation for each of the one or more sensed current values that meets a deviation threshold, enabling the machine learning model to identify subtle current distribution irregularities that may indicate developing connection issues.

For example, the controller 300 may use fixed-point multiplication with offset scaling instead of floating-point operations to improve computational efficiency on embedded systems. The fixed-point arithmetic may reduce computational overhead while maintaining sufficient precision for current measurement analysis, enabling the controller 300 to operate within the resource constraints of embedded battery management systems. The controller 300 may determine one or more correlations corresponding to one or more current pattern changes with vehicle operational conditions including temperature variation and vibration level based on the current imbalances for each of the connected battery modules.

The controller 300 may achieve computational efficiency through specific implementation techniques that provide technical improvements to battery monitoring hardware. For instance, the controller 300 may process current deviation determinations using a sliding window buffer of 100 data points, where each data point represents a 10ms measurement interval, enabling real-time analysis of one-second data segments while maintaining memory usage below 40KB. The fixed-point arithmetic implementation may reduce processing time from approximately 25ms to approximately 13.4ms per analysis cycle when compared to floating-point operations, allowing the controller 300 to complete loose connection detection within the 10ms constraint required for embedded battery management systems.

The controller 300 may implement static memory allocation for feature vector storage, utilizing predetermined arrays of 37 elements corresponding to statistical deviation measurements from each battery module, which may eliminate dynamic memory allocation overhead and reduce RAM fragmentation. This approach may enable the controller 300 to maintain consistent execution timing while processing current measurements from up to 12 battery modules simultaneously. The feature extraction process may utilize lookup tables for deviation threshold comparisons, reducing computational complexity from O(n²) to O(n) for current distribution analysis across multiple battery modules.

The controller 300 may apply bit-shifting operations for division by powers of two during average current determinations, replacing floating-point division operations that would otherwise require approximately 50-100 CPU cycles with bit-shift operations completing in 1-2 CPU cycles. The controller 300 may store preprocessed current measurements in circular buffers that automatically overwrite oldest data points, maintaining a continuous 10-second rolling window of measurements while preventing memory overflow conditions that could compromise system stability in resource-constrained embedded environments.

The controller 300 may identify one or more abnormal current patterns by distinguishing between a temporary current variation and a persistent current pattern indicative of connection degradation for each of the connected battery modules based on the correlations. The controller 300 may filter current measurements across each of the connected battery modules removing noise and transient spikes, ensuring that the feature extraction process focuses on persistent patterns that may indicate actual connection issues rather than temporary operational variations. The data preprocessing 520 and feature extraction 530 operations may collectively prepare battery system data for machine learning analysis while operating within the computational and memory constraints of embedded vehicle systems.

The controller 300 may detect abnormalities in current distribution patterns. For instance, the controller 300 may implement a trained artificial neural network that processes the feature vector containing statistical deviation measurements to identify patterns indicative of loose connections. The neural network may analyze the current distribution data by comparing individual battery module current deviations against learned patterns from training data that included both normal connection conditions and various degrees of connection degradation.

In one example, the controller 300 may detect an abnormality when current measurements from a first battery module consistently deviate by more than 15% from the determined average current across all modules over a 5-second analysis window. The feature extraction process may generate a feature vector showing that while battery modules 1, 2, and 4 maintain current values within 3% of the average baseline, battery module 3 exhibits current readings that are 18% below the average, indicating potential increased resistance due to a loose connection. The machine learning model may process this feature vector and determine that the pattern matches training data associated with progressive connection loosening by analyzing deviations from normal patterns.

The controller 300 may distinguish abnormal patterns from temporary operational variations by analyzing the persistence and consistency of the deviation over multiple measurement cycles. Unlike transient current fluctuations that may occur during normal vehicle acceleration or deceleration, a loose connection may manifest as a sustained reduction in current contribution from the affected module, creating a characteristic signature that the trained neural network can recognize. The system may generate an anomaly score based on the magnitude and duration of the current deviation, triggering a loose connection alert when the score exceeds a predetermined threshold established during the training phase.

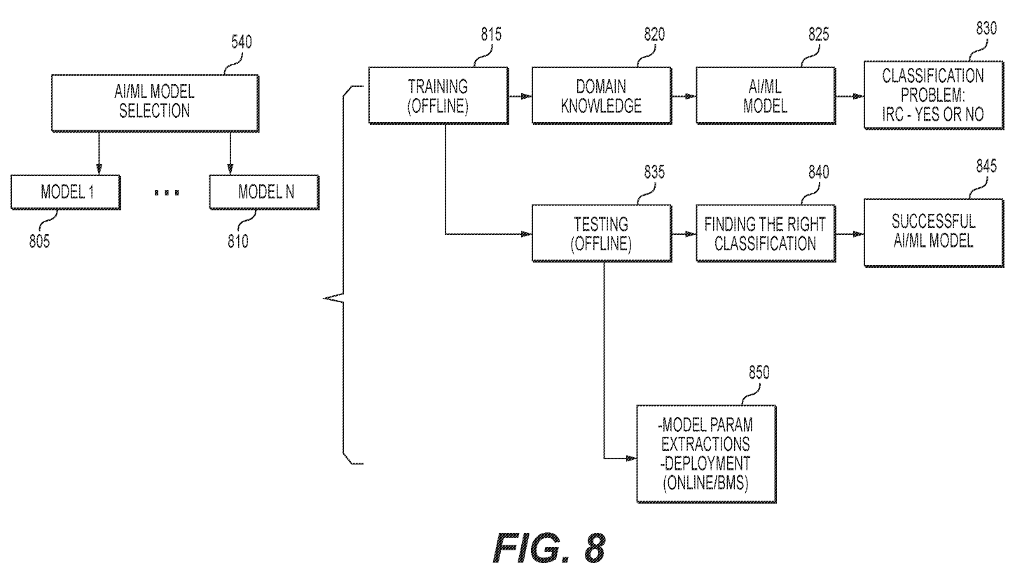

FIG. 8 depicts a flowchart illustrating machine learning model selection and deployment for detecting loose connections in a battery system of FIG. 5, according to one or more embodiments. The AI/ML model selection 540 may include a process for selecting, training, and deploying machine learning models for loose connection detection in battery systems. The AI/ML model selection 540 may begin with a selection between multiple model options, including a model 1 805 and a model N 810, where the model 1 805 may represent an artificial neural network implementation and the model N 810 may represent a logistic regression implementation. One or more embodiments may utilize more or less models as needed based on the resources available and the application of use. The controller 300 may evaluate one or more model architectures to determine which approach may provide optimal performance for the specific requirements of embedded battery management systems.

The model 1 805 may be implemented as an artificial neural network with a specific architecture including one input layer, two hidden layers with two neurons each, and one output layer. One or more embodiments, model 1 805 may include more or less input layers, hidden layer, neurons, and/or output layers. The artificial neural network architecture may process feature vectors containing current deviation measurements through multiple layers of weighted connections and activation functions. The controller 300 may implement the artificial neural network using predetermined weights and biases that have been optimized during training to recognize patterns associated with loose connections in battery systems.

The model N 810 may be implemented as a logistic regression model with specific coefficients including a coefficient (e.g., approximately 38.89) and an intercept (e.g., approximately -8.64). The logistic regression implementation may provide a computationally efficient alternative to the neural network approach, requiring fewer mathematical operations while maintaining accuracy for binary classification of connection states. The controller 300 may apply the logistic regression model by multiplying input features by the coefficient and adding the intercept value before applying an activation function to generate a classification output.

Following model selection, the AI/ML model selection 540 may proceed to an operation 815 that may involve training the selected model. The operation 815 may implement training algorithms including backpropagation and gradient descent to adjust model parameters based on training data that includes current measurements from battery systems under various connection conditions. The controller 300 may perform the operation 815 by iteratively adjusting one or more parameters of the machine learning model based on associations between extracted features and known connection states from training data.

The training process during the operation 815 may involve performing one or more dot products including one or more weights to features extracted from training data. The controller 300 may add one or more biases to the features and apply a sigmoid activation function to generate model outputs during training. For example, the controller 300 may implement a fast sigmoid approximation function f(x) = x/(1+|x|) instead of the standard sigmoid function to reduce computational overhead while maintaining sufficient accuracy for classification tasks.

The AI/ML model selection 540 may continue with an operation 820 that may apply domain knowledge to the training process. The operation 820 may incorporate understanding of battery system behavior and connection degradation patterns to guide model development and parameter selection. The controller 300 may implement the operation 820 by integrating knowledge of electrical resistance characteristics, current distribution patterns, and connection failure modes to enhance model training effectiveness.

Following the operation 820, the AI/ML model selection 540 may proceed to an operation 825 that may involve testing the trained model. The operation 825 may evaluate model performance using validation data sets that include current measurements from battery systems with known connection states. The controller 300 may implement the operation 825 by comparing model predictions against known connection states in test data and determining performance metrics including accuracy, precision, recall, and F1-score. The operation 825 may verify that false positive rates remain below a predetermined threshold to reduce driver annoyance, while confirming that false negative rates remain approximately zero to ensure safety-critical loose connections are detected. The controller 300 may collect test data from vehicle battery management system operations during the operation 825 to validate model performance under real-world operating conditions.

The AI/ML model selection 540 may advance to an operation 830 that may extract model parameters and perform manual deployment without dedicated libraries. The operation 830 may enable embedded system implementation by extracting trained weights, biases, and other model parameters for manual integration into resource-constrained embedded systems. The controller 300 may implement the operation 830 by converting trained model parameters into static arrays and constants that can be deployed without requiring machine learning libraries that may exceed memory constraints of embedded systems.

Following the operation 830, the AI/ML model selection 540 may proceed to an operation 835 that may involve offline testing of the deployed model. The operation 835 may validate model performance in the target embedded environment before transitioning to online operation. The controller 300 may implement the operation 835 by processing historical battery system data through the deployed model to verify that performance metrics remain consistent with laboratory validation results. The operation 835 may ensure that the machine learning model is trained offline such that resources of the battery system do not exceed a resource threshold. The controller 300 may maintain execution time constraints of less than 10ms per analysis cycle and RAM usage at approximately 54% of available memory during the operation 835. The controller 300 may implement memory management techniques including memory pooling, immediate deallocation after use, and maintaining memory usage below 60-65% of available stack capacity.

The AI/ML model selection 540 may continue with an operation 840 that may determine the right classification threshold for distinguishing between normal and abnormal connection states. The operation 840 may optimize the decision boundary to balance detection sensitivity with false positive rates based on validation data analysis. The controller 300 may implement the operation 840 by analyzing receiver operating characteristic curves and selecting threshold values that increase detection accuracy while reducing false alarms.

Following the operation 840, the AI/ML model selection 540 may proceed to an operation 845 that may involve developing a successful AI/ML model with validated performance characteristics. The operation 845 may finalize model configuration and parameters based on testing results from previous operations. The controller 300 may implement the operation 845 by confirming that the trained machine learning model achieves target performance metrics including 100% accuracy, precision, recall, and F1-score based on validation testing.

The AI/ML model selection 540 may continue to an operation 850 that may extract final model parameters and deploy the model for online operation. The operation 850 may transition the validated model from offline testing to real-time operation within the vehicle battery management system. The controller 300 may implement the operation 850 by deploying the trained machine learning model to an embedded system of a vehicle battery management system with model parameters optimized for resource-constrained embedded systems. The controller 300 may validate performance of the deployed machine learning model using test data from the vehicle battery management system during the operation 850. The validation process may include continuous monitoring of model outputs and performance metrics to ensure that loose connection detection capabilities remain effective under varying operational conditions. The controller 300 may implement the machine learning model training at predetermined intervals to maintain model accuracy as battery systems age and operating conditions change over time.

The machine learning model may include one or more hidden layers, wherein the hidden layers are associated with features extracted from current measurement data. The hidden layers may process feature vectors through weighted connections and activation functions to identify complex patterns in current distribution data that indicate developing connection issues. The controller 300 may implement the hidden layers using static memory allocation and predetermined weight matrices to reduce computational overhead while maintaining pattern recognition capabilities within embedded system constraints.

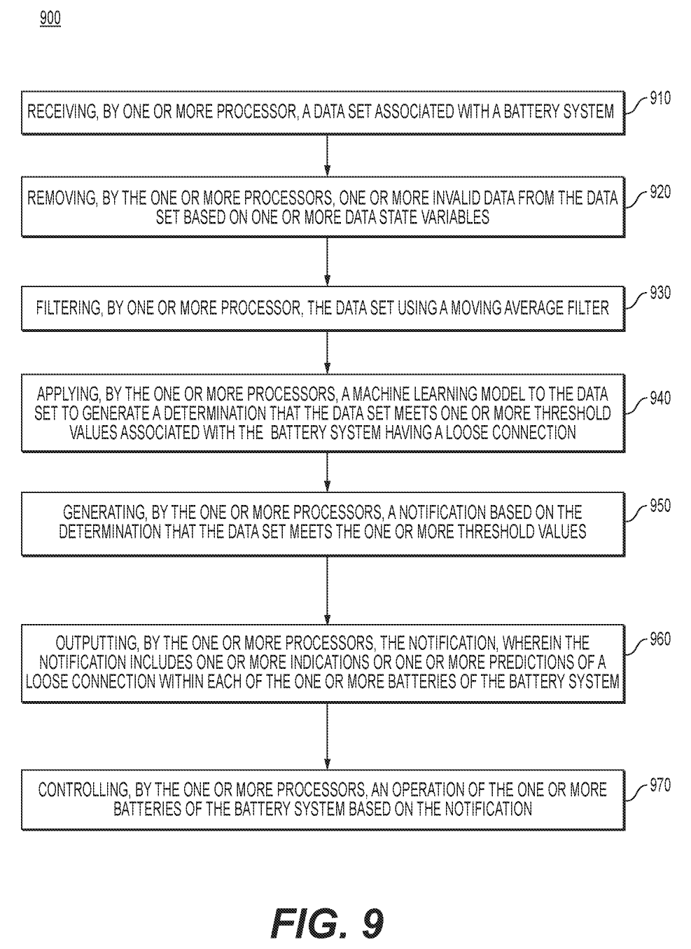

FIG. 9 depicts a flowchart for detecting and responding to loose connections in a battery system, according to one or more embodiments. A method 900 may illustrate a detection and response process for identifying and managing loose connections in battery systems. The method 900 may provide an end-to-end operational sequence that integrates data collection, analysis, notification, and control functions within a unified battery management framework. The method 900 may begin with an operation 910 that may receive a data set associated with a battery system. The operation 910 may collect electrical measurement data from the battery 200 during normal vehicle operation, where the data set may include one or more sensed current values associated with one or more batteries of the battery system over a period of time. The controller 300 may implement the operation 910 by sampling current measurements from each battery module 205 at predetermined intervals, for example 10ms sampling intervals, to capture detailed electrical characteristics during various operational states including charging, discharging, and idle conditions.

The method 900 may continue with an operation 920 that may remove one or more invalid data from the data set based on one or more data state variables. The operation 920 may implement data validation techniques to ensure that subsequent analysis utilizes only reliable sensor measurements. The controller 300 may execute the operation 920 by evaluating data state variables associated with each current measurement, where data state variables may indicate measurement validity through binary indicators with values of 1 for valid measurements and 0 for invalid measurements. The operation 920 may filter out sensor readings that may be compromised due to electrical noise, sensor malfunction, or measurement conditions outside of calibrated ranges.

Following the operation 920, the method 900 may proceed to an operation 930 that may filter the data set using a moving average filter. The operation 930 may apply signal processing techniques to reduce noise and improve measurement accuracy in the current sensor data. The controller 300 may implement the operation 930 with 10ms sampling intervals processed in chunks of 100 rows representing one second of data, enabling real-time analysis while managing memory usage within embedded system constraints. The moving average filter may smooth transient variations in current measurements while preserving underlying patterns that may indicate connection degradation.

The method 900 may advance to an operation 940 that may apply a machine learning model to the data set to generate a determination that the data set meets one or more threshold values associated with the battery system having a loose connection. The operation 940 may utilize the trained machine learning model 440 to analyze current distribution patterns and identify anomalies indicative of loose connections. The controller 300 may execute the operation 940 with execution time less than 10ms and RAM usage at approximately 54%, ensuring that loose connection detection operates within the resource constraints of embedded battery management systems. The one or more threshold values may be based on an operating state of the one or more batteries of the battery system and an associated sensed current for each of the one or more batteries of the battery system, enabling adaptive detection that accounts for varying operational conditions. The controller 300 may implement dynamic threshold adjustment during the operation 940, where the one or more threshold values may be dynamically adjusted based on at least one of an age of a vehicle containing the battery system, a type of the vehicle, a number of batteries within the battery system, or an operating history of the battery system. This adaptive approach may account for changes in battery characteristics over time and variations in system configuration that could affect normal current distribution patterns.

Following the operation 940, the method 900 may proceed to an operation 950 that may generate a notification based on the determination that the data set meets the one or more threshold values. The operation 950 may create diagnostic information that provides detailed analysis of detected connection issues. The controller 300 may implement the operation 950 to generate notifications where the one or more indications may include a connection strength percentage, an oxidation percentage, or a resistance increase percentage, and wherein the one or more predictions may include a predicted connection strength over time, an oxidation percentage over time, or a resistance increase percentage over time. The operation 950 may predict a connection failure progression based on the one or more abnormal current patterns and historical degradation data, enabling proactive maintenance planning.

The method 900 may continue with an operation 960 that may output the notification, wherein the notification includes one or more indications or one or more predictions of a loose connection within each of the one or more batteries of the battery system. The operation 960 may provide visual indicators through the display 310 with specific performance requirements including zero false positives to avoid driver annoyance and zero or minimal false negatives for safety. The controller 300 may implement the operation 960 to achieve optimal driver experience by ensuring that notifications are accurate and actionable, preventing unnecessary maintenance alerts while maintaining safety through reliable detection of actual connection issues.

The operation 960 may generate and display notifications to users through various interface mechanisms to communicate detected loose connection conditions. For example, when the machine learning model identifies a loose connection in battery module 205, the controller 300 may generate a notification message stating "Battery Module 3 Connection Alert: Resistance increase detected at 15% above normal threshold. Predicted degradation timeline: 2-3 months. Schedule maintenance inspection recommended." The notification may be displayed on the display 310 with visual indicators including color-coded status symbols, where green may indicate normal operation, yellow may indicate developing issues requiring monitoring, and red may indicate immediate attention required. The controller 300 may implement multi-modal notification delivery where the same alert information may be transmitted through the vehicle's infotainment system, mobile application connectivity, or fleet management interfaces. The notification may include specific diagnostic details such as "Connection strength: 78% (normal range 85-100%), Oxidation level: 12% (threshold 15%), Resistance trend: +2.3% per month over last 6 months." The system may provide contextual information to help users understand the significance of the alert, such as "Current performance impact: Minimal. Recommended action: Schedule inspection within 30 days to prevent potential system degradation."

The operation 960 may customize notification content based on the recipient, where technician-level alerts may include detailed technical parameters such as current deviation percentages and specific battery module identifiers, while driver-facing notifications may present simplified status information such as "Battery system monitoring detected a developing issue. Service recommended within 30 days. Current driving performance not affected." The controller 300 may implement notification prioritization where immediate safety concerns may trigger prominent visual and audible alerts, while predictive maintenance recommendations may be presented through less intrusive dashboard indicators or scheduled maintenance reminders.

The operation 960 may integrate with diagnostic trouble codes (DTCs) within existing battery management systems for coordinated fault detection and response. The controller 300 may generate standardized diagnostic codes that correspond to specific types of connection issues, enabling integration with vehicle diagnostic systems and maintenance protocols. The operation 960 may transmit one or more maintenance alerts to a vehicle operator before connection failures cause system shutdown, providing advance warning that enables scheduled maintenance rather than emergency repairs.

The method 900 may continue to an operation 970 that may control an operation of the one or more batteries of the battery system based on the notification. The operation 970 may implement protective measures to prevent further degradation of loose connections while maintaining system functionality. The controller 300 may execute the operation 970 where the operation may include one or more of changing an operating state of the one or more batteries, limiting an operational load of each of the one or more batteries, reducing the operation load of each of the one or more batteries, or preventing a next start operation of the battery system. The operation 970 may automatically adjust a battery module load distribution to reduce stress on degraded connections, enabling continued operation under monitored conditions while maintenance is scheduled.

The controller 300 may implement the operation 970 by redistributing current loads away from battery modules with detected connection issues, preventing overloading of properly connected modules while reducing stress on degraded connections. For example, if the machine learning analysis identifies a loose connection in battery module 205, the controller 300 may reduce the charging or discharging current for that module while increasing utilization of other modules to maintain overall system performance. The operation 970 may prevent progression of connection degradation by limiting current flow through affected connections, reducing heat generation and mechanical stress that could otherwise accelerate connection failure.

The battery system may further include a third data, wherein the third data may include one or more sensed temperature values associated with each of the one or more batteries of the battery system. The controller 300 may utilize temperature measurements in conjunction with current sensor data to enhance loose connection detection accuracy, as connection resistance increases may manifest as localized heating that can be detected through temperature monitoring. The integration of temperature data may provide additional validation of loose connection detection and enable more comprehensive assessment of connection health.

The method 900 may operate continuously during vehicle operation, providing real-time monitoring and response capabilities that enhance battery system reliability and safety. The controller 300 may maintain execution timing constraints throughout the method 900, ensuring that loose connection detection and response functions do not interfere with other battery management operations. The integrated approach of the method 900 may enable early detection of connection issues, proactive maintenance scheduling, and protective operational adjustments that extend battery system service life while maintaining safety and performance standards.

The disclosed system may provide significant technological improvements over conventional battery management approaches by implementing machine learning-based predictive analysis that operates within the resource constraints of embedded vehicle systems. Traditional battery management systems may rely on threshold-based monitoring that only detects connection issues after significant degradation has occurred, whereas the disclosed approach may identify subtle current distribution patterns that indicate developing connection problems months or years before conventional systems would recognize the issue. The machine learning model may process current sensor data in real-time using feature extraction techniques that determine average current values across battery packs and determine individual deviations, enabling detection of intermittent resistance conditions that would otherwise remain undetected until they progress to more severe failure states.

The system may enhance battery hardware performance and longevity by preventing the progression of loose connections that could otherwise lead to increased resistance, heat generation, and potential arcing conditions. By detecting connection degradation in its early stages, the disclosed approach may reduce thermal stress on bus bars, connectors, and adjacent battery cells that would occur as connection resistance increases over time. The early warning capabilities may enable proactive maintenance interventions that prevent more severe failure states, thereby reducing mechanical stress on connection hardware and extending the operational lifetime of electrical connections within the battery system. The software may also reduce energy consumption by preventing resistive losses that occur when connections degrade, maintaining optimal electrical conductivity and reducing energy losses that would otherwise be dissipated as heat.

The computational efficiency of the disclosed system may represent a substantial improvement in embedded battery management technology, achieving execution times of approximately 13.4 milliseconds per processing cycle while maintaining RAM usage at a predetermined level of available capacity. The system may utilize static memory allocation techniques, fixed-size buffers, and optimized feature extraction algorithms that reduce computational overhead without sacrificing detection accuracy. This efficient implementation may enable continuous real-time monitoring without impacting other battery management functions, while the machine learning models may be deployed without requiring dedicated libraries that would exceed memory constraints of embedded systems. The adaptive threshold adjustment capabilities may account for battery aging and varying operational conditions, providing sustained detection accuracy throughout the battery system's service life.

It should be understood that the foregoing description is intended to illustrate, and not to limit, the scope of the present disclosure. Other embodiments will be apparent to those skilled in the art in view of this description. For example, while certain embodiments are described with respect to lithium-ion batteries, the disclosed structures, materials, and methods may be applied to next-generation energy storage devices including, without limitation, solid-state batteries employing solid electrolytes, lithium-metal or lithium-sulfur chemistries, sodium-ion systems, multivalent-ion systems (e.g., magnesium, calcium, aluminum), zinc-based or redox flow batteries, and metal-air cells. Still further embodiments may include architectures employing silicon-based anodes, cobalt-free cathodes, or advanced electrolyte formulations. In some cases, anode-less designs, in which active material is plated during charge, or separator-free designs, in which the electrolyte provides ionic conduction and electronic insulation without a discrete separator, may be implemented. The present disclosure also contemplates hybridized devices combining electrochemical cells with supercapacitors, as well as integration into applications such as electric or hybrid vehicles, stationary energy storage systems, aerospace platforms, and portable electronics. Accordingly, the scope of the present invention should be determined not by the particular embodiments described, but by reference to the appended claims and their equivalents.

The present disclosure further relates to the following aspects.

Example 1. A method comprising: receiving, by one or more processors, a data set associated with a battery system, wherein the data set includes one or more sensed current values associated with one or more batteries of the battery system over a period of time; determining one or more threshold values based on one or more of an operating state of the battery system or the one or more sensed current values associated with the one or more batteries of the battery system; applying, by the one or more processors, a machine learning model to the data set to generate a determination that the data set meets the one or more threshold values associated with the battery system having a loose connection, wherein the machine learning model is trained at one or more intervals, and wherein the machine learning model is trained offline, such that when the machine learning model is implemented within the battery system, one or more resources of the battery system remains below a resource threshold, so that a controller of the battery system performs the determination within a predetermined amount of time; and controlling, by the one or more processors, an operation of the battery system based on the determination that the data set meets the one or more threshold values associated with the battery system having the loose connection.

Example 2. The method of example 1, further comprising: removing, by the one or more processors, invalid data from the data set based on one or more data state variables; filtering, by the one or more processors, the data set using a moving average filter; and generating the one or more sensed current values associated with the one or more batteries of the battery system over the period of time using one or more sensors.

Example 3. The method of example 2, wherein the one or more data state variables includes one or more sensed current values associated with one or more batteries of the battery system not exceeding 10% of a maximum load of the battery system.

Example 4. The method of example 1, wherein the machine learning model is trained by: receiving first data regarding an element attribute, wherein the first data is associated with the battery system; extracting a first feature from the first data; receiving second data regarding a training prediction value related to the element attribute; extracting a second feature from the second data; and training the machine learning model to learn an association between the element attribute and the training prediction value related to the element attribute, based on the first feature and the second feature.

Example 5. The method of example 4, wherein extracting the first feature includes: averaging, by the one or more processors, one or more sensed current values associated with one or more batteries of the battery system; determining, by the one or more processors, a deviation for each of the one or more sensed current values based on averaging the one or more sensed current values; and determining, by the one or more processors, the first feature based on the deviation for each of the one or more sensed current values that meets a deviation threshold.

Example 6. The method of example 5, wherein determining the first feature further includes: applying, by the one or more processors, one or more dot products including one or more weights to the first feature; adding, by the one or more processors, one or more biases to the first feature; and applying, by the one or more processors, a sigmoid activation function to the first feature.

Example 7. The method of example 4, wherein the machine learning model includes one or more hidden layers, wherein the one or more hidden layers are associated with the first feature and the second feature.

Example 8. The method of example 1, wherein determining the one or more threshold values further includes: determining the one or more threshold values based on a deviation value associated with each of the one or more sensed current values, wherein the deviation value is based on one or more of historical data or one or more system characteristics of the one or more batteries of the battery system.

Example 9. The method of example 1, further comprising: generating, by the one or more processors, a notification based on the determination that the data set meets the one or more threshold values; and outputting, by the one or more processors, the notification, wherein the notification includes one or more indications or one or more predictions of the loose connection of the battery system.

Example 10. The method of example 9, wherein: the one or more indications include one or more of a connection strength percentage, an oxidation percentage, or a resistance increase percentage, and the one or more predictions include one or more of a prediction of the connection strength percentage over time, a prediction of the oxidation percentage over time, or a prediction of the resistance increase percentage over time.

Example 11. The method of example 1, wherein the operation includes one or more of changing an operating state of the one or more batteries of the battery system, limiting an operational load of each of the one or more batteries, reducing the operational load of the one or more batteries, or preventing a next start operation of the battery system.

Example 12. The method of example 1, wherein the data set further includes one or more sensed temperature values associated with the one or more batteries of the battery system.

Example 13. The method of example 1, further comprising: adjusting the one or more threshold values based on one or more of: an age of a vehicle containing the battery system, a type of the vehicle, a number of batteries of the battery system, or an operating history of the battery system.

Example 14. The method of example 1, wherein the machine learning model is trained using historical data from a plurality of battery systems under various connection conditions, including normal connection conditions and progressively loosened connection conditions with different degrees of resistance increase.

Example 15. A method for battery health monitoring in a battery energy storage system, the method comprising: receiving, by one or more processors, operational data from a plurality of batteries of the battery energy storage system; applying, by the one or more processors, a machine learning model to the operational data from the plurality of batteries to generate a determination that the operational data meets one or more threshold values associated with a battery health assessment, wherein applying the machine learning model to the operational data includes: detecting, by the one or more processors, one or more abnormal current patterns in the operational data, detecting, by the one or more processors, one or more connection failure progressions based on the one or more abnormal current patterns and historical degradation data in the operational data, and generating, by the one or more processors, the battery health assessment based on the one or more abnormal current patterns and the one or more connection failure progressions; and initiating, by the one or more processors, a maintenance action when the battery health assessment meets the one or more threshold values.

Example 16. The method of example 15, wherein detecting the one or more abnormal current patterns includes: determining one or more statistical deviation currents for each of one or more connected batteries from an average current value; detecting current imbalances for each of the one or more connected batteries based on the one or more statistical deviation currents for each of the one or more connected batteries; determining one or more correlations corresponding to one or more current pattern changes with vehicle operational conditions including a temperature variation and a vibration level based on the current imbalances for each of the one or more connected batteries; and determining the one or more abnormal current patterns by distinguishing between a temporary current variation and a persistent current pattern indicative of connection degradation for each of the one or more connected batteries based on the one or more correlations.

Example 17. The method of example 15, wherein detecting the one or more connection failure progressions includes analyzing changes in one or more current values from each of the plurality of batteries at one or more intervals during operation.

Example 18. A method for training a machine learning model to predict a health of a battery in a battery energy storage system, the method comprising: receiving, by one or more processors, first data associated with each of a plurality of batteries of the battery energy storage system, wherein the first data includes a plurality of operational parameters; extracting, by the one or more processors, one or more features from the first data based on analyzing processing algorithms identifying one or more battery operational parameters; training, by the one or more processors, the machine learning model to determine correlations between the plurality of operational parameters and one or more health assessment values based on the one or more features; and validating, by the one or more processors, the machine learning model using validation data.

Example 19. The method of example 18, wherein the plurality of operational parameters includes one or more of a sensed current value, a charging rate, a sensed temperature value, or a load limitation.

Example 20. The method of example 18, wherein the one or more health assessment values include one or more of a current deviation or a current average.

Example 21. A system for controlling a battery system, the system comprising: one or more processors; and one or more memories storing instructions that, when executed by the one or more processors, cause the one or more processors to perform operations including: receiving a data set associated with a battery system, wherein the data set includes one or more sensed current values associated with one or more batteries of the battery system over a period of time; determining one or more threshold values based on one or more of an operating state of the battery system or the one or more sensed current values associated with the one or more batteries of the battery system; applying a machine learning model to the data set to generate a determination that the data set meets the one or more threshold values associated with the battery system having a loose connection, wherein the machine learning model is trained at one or more intervals, and wherein the machine learning model is trained offline, such that when the machine learning model is implemented within the battery system, one or more resources of the battery system remains below a resource threshold, so that a controller of the battery system performs the determination within a predetermined amount of time; and controlling an operation of the battery system based on the determination that the data set meets the one or more threshold values associated with the battery system having the loose connection.

Example 22. The system of example 21, wherein the operations further include any of examples 2 to 14.

Example 23. A system for battery health monitoring in a battery energy storage system, the system comprising: one or more processors; and one or more memories storing instructions that, when executed by the one or more processors, cause the one or more processors to perform operations including: receiving, by the one or more processors, operational data from a plurality of batteries of the battery energy storage system; applying, by the one or more processors, a machine learning model to the operational data from the plurality of batteries to generate a determination that the operational data meets one or more threshold values associated with a battery health assessment, wherein applying the machine learning model to the operational data includes: detecting, by the one or more processors, one or more abnormal current patterns in the operational data, detecting, by the one or more processors, one or more connection failure progressions based on the one or more abnormal current patterns and historical degradation data in the operational data, and generating, by the one or more processors, the battery health assessment based on the one or more abnormal current patterns and the one or more connection failure progressions; and initiating, by the one or more processors, a maintenance action when the battery health assessment meets the one or more threshold values.

Example 24. The system of example 23, wherein the operations further include any of examples 16 to 17.

Example 25. A system for training a machine learning model to predict a health of a battery in a battery energy storage system, the system comprising: one or more processors; and one or more memories storing instructions that, when executed by the one or more processors, cause the one or more processors to perform operations including: receiving, by the one or more processors, first data associated with each of a plurality of batteries of the battery energy storage system, wherein the first data includes a plurality of operational parameters; extracting, by the one or more processors, one or more features from the first data based on analyzing processing algorithms identifying one or more battery operational parameters; training, by the one or more processors, the machine learning model to determine correlations between the plurality of operational parameters and one or more health assessment values based on the one or more features; and validating, by the one or more processors, the machine learning model using validation data.

Example 26. The system of example 25, wherein the operations further include any of examples 19 to 20.

Example 27. A non-transitory computer-readable medium for controlling a battery system, storing instructions that, when executed by one or more processors, cause the one or more processors to: receive a data set associated with a battery system, wherein the data set includes one or more sensed current values associated with one or more batteries of the battery system over a period of time; determine one or more threshold values based on one or more of an operating state of the battery system or the one or more sensed current values associated with the one or more batteries of the battery system; apply a machine learning model to the data set to generate a determination that the data set meets the one or more threshold values associated with the battery system having a loose connection, wherein the machine learning model is trained at one or more intervals, and wherein the machine learning model is trained offline, such that when the machine learning model is implemented within the battery system, one or more resources of the battery system remains below a resource threshold, so that a controller of the battery system performs the determination within a predetermined amount of time; and control an operation of the battery system based on the determination that the data set meets the one or more threshold values associated with the battery system having the loose connection.

Example 28. The non-transitory computer readable medium of example 27, wherein the operations further include any of examples 2 to 14.

Example 29. A non-transitory computer readable medium for battery health monitoring in a battery energy storage system, storing instructions that, when executed by one or more processors, cause the one or more processors to: receive operational data from a plurality of batteries of the battery energy storage system; apply a machine learning model to the operational data from the plurality of batteries to generate a determination that the operational data meets one or more threshold values associated with a battery health assessment, wherein applying the machine learning model to the operational data includes: detect one or more abnormal current patterns in the operational data, detect one or more connection failure progressions based on the one or more abnormal current patterns and historical degradation data in the operational data, and generate the battery health assessment based on the one or more abnormal current patterns and the one or more connection failure progressions; and initiate a maintenance action when the battery health assessment meets the one or more threshold values.

Example 30. The non-transitory computer readable medium of example 29, wherein the operations further include any of examples 16 to 17.

Example 31. A non-transitory computer readable medium for training a machine learning model to predict a health of a battery in a battery energy storage system, storing instructions that, when executed by one or more processors, cause the one or more processors to: receive first data associated with each of a plurality of batteries of the battery energy storage system, wherein the first data includes a plurality of operational parameters; extract one or more features from the first data based on analyzing processing algorithms identifying one or more battery operational parameters; train the machine learning model to determine correlations between the plurality of operational parameters and one or more health assessment values based on the one or more features; and validate the machine learning model using validation data.

Example 32. The non-transitory computer readable medium of example 31, wherein the operations further include any of examples 19 to 20.

Other embodiments of the disclosure will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A method comprising:
receiving, by one or more processors, a data set associated with a battery system, wherein the data set includes one or more sensed current values associated with one or more batteries of the battery system over a period of time;
determining one or more threshold values based on one or more of an operating state of the battery system or the one or more sensed current values associated with the one or more batteries of the battery system;
applying, by the one or more processors, a machine learning model to the data set to generate a determination that the data set meets the one or more threshold values associated with the battery system having a loose connection, wherein the machine learning model is trained at one or more intervals, and wherein the machine learning model is trained offline, such that when the machine learning model is implemented within the battery system, one or more resources of the battery system remains below a resource threshold, so that a controller of the battery system performs the determination within a predetermined amount of time; and
controlling, by the one or more processors, an operation of the battery system based on the determination that the data set meets the one or more threshold values associated with the battery system having the loose connection.

2. The method of claim 1, further comprising:
removing, by the one or more processors, invalid data from the data set based on one or more data state variables;
filtering, by the one or more processors, the data set using a moving average filter; and
generating the one or more sensed current values associated with the one or more batteries of the battery system over the period of time using one or more sensors.

3. The method of claim 2, wherein the one or more data state variables includes one or more sensed current values associated with one or more batteries of the battery system not exceeding 10% of a maximum load of the battery system.

4. The method of claim 1, wherein the machine learning model is trained by:
receiving first data regarding an element attribute, wherein the first data is associated with the battery system;
extracting a first feature from the first data;
receiving second data regarding a training prediction value related to the element attribute;
extracting a second feature from the second data; and
training the machine learning model to learn an association between the element attribute and the training prediction value related to the element attribute, based on the first feature and the second feature.

5. The method of claim 4, wherein extracting the first feature includes:
averaging, by the one or more processors, one or more sensed current values associated with one or more batteries of the battery system;
determining, by the one or more processors, a deviation for each of the one or more sensed current values based on averaging the one or more sensed current values; and
determining, by the one or more processors, the first feature based on the deviation for each of the one or more sensed current values that meets a deviation threshold.

6. The method of claim 5, wherein determining the first feature further includes:
applying, by the one or more processors, one or more dot products including one or more weights to the first feature;
adding, by the one or more processors, one or more biases to the first feature; and
applying, by the one or more processors, a sigmoid activation function to the first feature.

7. The method of claim 4, wherein the machine learning model includes one or more hidden layers, wherein the one or more hidden layers are associated with the first feature and the second feature.

8. The method of claim 1, wherein determining the one or more threshold values further includes:
determining the one or more threshold values based on a deviation value associated with each of the one or more sensed current values, wherein the deviation value is based on one or more of historical data or one or more system characteristics of the one or more batteries of the battery system.

9. The method of claim 1, further comprising:
generating, by the one or more processors, a notification based on the determination that the data set meets the one or more threshold values; and
outputting, by the one or more processors, the notification, wherein the notification includes one or more indications or one or more predictions of the loose connection of the battery system.

10. The method of claim 9, wherein:
the one or more indications include one or more of a connection strength percentage, an oxidation percentage, or a resistance increase percentage, and
the one or more predictions include one or more of a prediction of the connection strength percentage over time, a prediction of the oxidation percentage over time, or a prediction of the resistance increase percentage over time.

11. The method of claim 1, wherein the operation includes one or more of changing an operating state of the one or more batteries of the battery system, limiting an operational load of each of the one or more batteries, reducing the operational load of the one or more batteries, or preventing a next start operation of the battery system.

12. The method of claim 1, wherein the data set further includes one or more sensed temperature values associated with the one or more batteries of the battery system.

13. The method of claim 1, further comprising:
adjusting the one or more threshold values based on one or more of: an age of a vehicle containing the battery system, a type of the vehicle, a number of batteries of the battery system, or an operating history of the battery system.

14. The method of claim 1, wherein the machine learning model is trained using historical data from a plurality of battery systems under various connection conditions, including normal connection conditions and progressively loosened connection conditions with different degrees of resistance increase.

15. A method for battery health monitoring in a battery energy storage system, the method comprising:
receiving, by one or more processors, operational data from a plurality of batteries of the battery energy storage system;
applying, by the one or more processors, a machine learning model to the operational data from the plurality of batteries to generate a determination that the operational data meets one or more threshold values associated with a battery health assessment, wherein applying the machine learning model to the operational data includes:
detecting, by the one or more processors, one or more abnormal current patterns in the operational data,
detecting, by the one or more processors, one or more connection failure progressions based on the one or more abnormal current patterns and historical degradation data in the operational data, and
generating, by the one or more processors, the battery health assessment based on the one or more abnormal current patterns and the one or more connection failure progressions; and
initiating, by the one or more processors, a maintenance action when the battery health assessment meets the one or more threshold values.

16. The method of claim 15, wherein detecting the one or more abnormal current patterns includes:
determining one or more statistical deviation currents for each of one or more connected batteries from an average current value;
detecting current imbalances for each of the one or more connected batteries based on the one or more statistical deviation currents for each of the one or more connected batteries;
determining one or more correlations corresponding to one or more current pattern changes with vehicle operational conditions including a temperature variation and a vibration level based on the current imbalances for each of the one or more connected batteries; and
determining the one or more abnormal current patterns by distinguishing between a temporary current variation and a persistent current pattern indicative of connection degradation for each of the one or more connected batteries based on the one or more correlations.

17. The method of claim 15, wherein detecting the one or more connection failure progressions includes analyzing changes in one or more current values from each of the plurality of batteries at one or more intervals during operation.

18. A method for training a machine learning model to predict a health of a battery in a battery energy storage system, the method comprising:
receiving, by one or more processors, first data associated with each of a plurality of batteries of the battery energy storage system, wherein the first data includes a plurality of operational parameters;
extracting, by the one or more processors, one or more features from the first data based on analyzing processing algorithms identifying one or more battery operational parameters;
training, by the one or more processors, the machine learning model to determine correlations between the plurality of operational parameters and one or more health assessment values based on the one or more features; and
validating, by the one or more processors, the machine learning model using validation data.

19. The method of claim 18, wherein the plurality of operational parameters includes one or more of a sensed current value, a charging rate, a sensed temperature value, or a load limitation.

20. The method of claim 18, wherein the one or more health assessment values include one or more of a current deviation or a current average.
